(19) United States
(12) Patent Application Publication
(10) Pub. No.: US 2025/0110624 A1
(43) Pub. Date: Apr. 3, 2025

(54) TECHNIQUES AND USER INTERFACES FOR DISPLAYING CONTROLS

(71) Applicant: Apple Inc., Cupertino, CA (US)

(72) Inventors: Gemma A. ROPER, San Francisco, CA (US); Christopher P. FOSS, San Francisco, CA (US); Andrew S. KIM, Walnut Creek, CA (US); David A. KRIMSLEY, Sunnyvale, CA (US); Christopher D. MATTHEWS, San Francisco, CA (US); Corey K. WANG, Palo Alto, CA (US); Arian BEHZADI, San Francisco, CA (US)

(21) Appl. No.: 18/896,505

(22) Filed: Sep. 25, 2024

Related U.S. Application Data
(60) Provisional application No. 63/587,110, filed on Sep. 30, 2023.
(60) Provisional application No. 63/587,112, filed on Sep. 30, 2023.
(60) Provisional application No. 63/587,111, filed on Sep. 30, 2023.

(51) Int. Cl. G06F 3/04845; G06F 3/0482; G06F 3/0487

(52) U.S. Cl. CPC G06F 3/04845; G06F 3/0482; G06F 3/0487

(57) ABSTRACT

The present disclosure generally relates to controlling computer systems.

### CROSS-REFERENCE TO RELATED APPLICATIONS

This application claims priority to U.S. Provisional Patent Application Ser. No. 63/587,110 entitled “TECHNIQUES AND USER INTERFACES FOR DISPLAYING CONTROLS,” filed Sep. 30, 2023, to U.S. Provisional Patent Application Ser. No. 63/587,111 entitled “USER INTERFACES AND TECHNIQUES FOR DISPLAYING INFORMATION,” filed Sep. 30, 2023, and to U.S. Provisional Patent Application Ser. No. 63/587,112 entitled “TECHNIQUES AND USER INTERFACES FOR CONTROLLING ONE OR MORE ELECTRONIC DEVICES,” filed Sep. 30, 2023, which are incorporated by reference herein in their entireties for all purposes.

### FIELD

The present disclosure relates generally to computer user interfaces, and more specifically to techniques for displaying controls.

### BACKGROUND

Computer systems often display controls that correspond to external devices. The state of the external devices can be adjusted in response to the controls being selected. can indicate when operations are performed and/or input is detected.

### SUMMARY

Some techniques for displaying controls using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for displaying controls. Such methods and interfaces optionally complement or replace other methods for displaying controls. Such methods and interfaces reduce the cognitive burden on a user and produce a more efficient human-machine interface. For battery-operated computing devices, such methods and interfaces conserve power and increase the time between battery charges.

In some examples, a method that is performed at a computer system that is in communication with a display component and one or more input devices is described. In some embodiments, the method comprises: displaying, via the display component: a plurality of user interface objects including a first user interface object corresponding to a first setting and a second user interface object corresponding to a second setting that is different from the first setting; a first representation of a current value for the first setting; and a second representation of a current value for the second setting; while displaying the first user interface object, the second user interface object, the first representation, and the second representation, detecting, via the one or more input devices, a first input; and in response to detecting the first input: in accordance with a determination that the first input corresponds to selection of the first user interface object, updating display of the first user interface object to include a first scale corresponding to the first setting without updating display of the second user interface object to include a second scale corresponding to the second setting; and. in accordance with a determination that the first input corresponds to selection of the second user interface object, updating display of the second user interface object to include a second scale corresponding to the second setting without updating display of the first user interface object to include the first scale.

In some embodiments, a non-transitory computer-readable storage medium storing one or more programs configured to be executed by one or more processors of a computer system that is in communication with a display component and one or more input devices is described. In some embodiments, the one or more programs includes instructions for: displaying, via the display component: a plurality of user interface objects including a first user interface object corresponding to a first setting and a second user interface object corresponding to a second setting that is different from the first setting; a first representation of a current value for the first setting; and a second representation of a current value for the second setting; while displaying the first user interface object, the second user interface object, the first representation, and the second representation, detecting, via the one or more input devices, a first input; and in response to detecting the first input: in accordance with a determination that the first input corresponds to selection of the first user interface object, updating display of the first user interface object to include a first scale corresponding to the first setting without updating display of the second user interface object to include a second scale corresponding to the second setting; and. in accordance with a determination that the first input corresponds to selection of the second user interface object, updating display of the second user interface object to include a second scale corresponding to the second setting without updating display of the first user interface object to include the first scale.

In some embodiments, a transitory computer-readable storage medium storing one or more programs configured to be executed by one or more processors of a computer system that is in communication with a display component and one or more input devices is described. In some embodiments, the one or more programs includes instructions for: displaying, via the display component: a plurality of user interface objects including a first user interface object corresponding to a first setting and a second user interface object corresponding to a second setting that is different from the first setting; a first representation of a current value for the first setting; and a second representation of a current value for the second setting; while displaying the first user interface object, the second user interface object, the first representation, and the second representation, detecting, via the one or more input devices, a first input; and in response to detecting the first input: in accordance with a determination that the first input corresponds to selection of the first user interface object, updating display of the first user interface object to include a first scale corresponding to the first setting without updating display of the second user interface object to include a second scale corresponding to the second setting; and. in accordance with a determination that the first input corresponds to selection of the second user interface object, updating display of the second user interface object to include a second scale corresponding to the second setting without updating display of the first user interface object to include the first scale.

In some embodiments, a computer system that is in communication with a display component and one or more input devices is described. In some embodiments, the computer system that is in communication with a display component and one or more input devices comprises one or more processors and memory storing one or more programs configured to be executed by the one or more processors. In some embodiments, the one or more programs includes instructions for: displaying, via the display component: a plurality of user interface objects including a first user interface object corresponding to a first setting and a second user interface object corresponding to a second setting that is different from the first setting; a first representation of a current value for the first setting; and a second representation of a current value for the second setting; while displaying the first user interface object, the second user interface object, the first representation, and the second representation, detecting, via the one or more input devices, a first input; and in response to detecting the first input: in accordance with a determination that the first input corresponds to selection of the first user interface object, updating display of the first user interface object to include a first scale corresponding to the first setting without updating display of the second user interface object to include a second scale corresponding to the second setting; and. in accordance with a determination that the first input corresponds to selection of the second user interface object, updating display of the second user interface object to include a second scale corresponding to the second setting without updating display of the first user interface object to include the first scale.

In some embodiments, a computer system that is in communication with a display component and one or more input devices is described. In some embodiments, the computer system that is in communication with a display component and one or more input devices comprises means for performing each of the following steps: displaying, via the display component: a plurality of user interface objects including a first user interface object corresponding to a first setting and a second user interface object corresponding to a second setting that is different from the first setting; a first representation of a current value for the first setting; and a second representation of a current value for the second setting; while displaying the first user interface object, the second user interface object, the first representation, and the second representation, detecting, via the one or more input devices, a first input; and in response to detecting the first input: in accordance with a determination that the first input corresponds to selection of the first user interface object, updating display of the first user interface object to include a first scale corresponding to the first setting without updating display of the second user interface object to include a second scale corresponding to the second setting; and. in accordance with a determination that the first input corresponds to selection of the second user interface object, updating display of the second user interface object to include a second scale corresponding to the second setting without updating display of the first user interface object to include the first scale.

In some embodiments, a computer program product is described. In some embodiments, the computer program product comprises one or more programs configured to be executed by one or more processors of a computer system that is in communication with a display component and one or more input devices. In some embodiments, the one or more programs include instructions for: displaying, via the display component: a plurality of user interface objects including a first user interface object corresponding to a first setting and a second user interface object corresponding to a second setting that is different from the first setting; a first representation of a current value for the first setting; and a second representation of a current value for the second setting; while displaying the first user interface object, the second user interface object, the first representation, and the second representation, detecting, via the one or more input devices, a first input; and in response to detecting the first input: in accordance with a determination that the first input corresponds to selection of the first user interface object, updating display of the first user interface object to include a first scale corresponding to the first setting without updating display of the second user interface object to include a second scale corresponding to the second setting; and. in accordance with a determination that the first input corresponds to selection of the second user interface object, updating display of the second user interface object to include a second scale corresponding to the second setting without updating display of the first user interface object to include the first scale.

In some examples, a method that is performed at a computer system that is in communication with a display component, one or more input devices, and a physical input mechanism is described. In some embodiments, the method comprises: while displaying a respective user interface, detecting, via the one or more inputs devices, an intent to control the physical input mechanism; in response to detecting the intent to control the physical input mechanism, displaying, via the display component, one or more user interface objects on the respective user interface, wherein movement of the physical input mechanism causes the computer system to update display at least one of the one or more user interface objects; and while displaying the one or more respective user interface objects on the respective user interface: in accordance with a determination that the physical input mechanism is not moving, the intent to control the physical input mechanism continues to be detected, and a predetermined period of time has not passed, continuing to display the one or more respective user interface objects on the respective user interface; in accordance with a determination that the physical input mechanism is not moving, the intent to control the physical input mechanism continues to be detected, and a predetermined period of time has passed, ceasing to display the one or more respective user interface objects on the respective user interface; and in accordance with a determination that the physical input mechanism is not moving and the intent to control the physical input mechanism does not continue to be detected, ceasing to display the one or more respective user interface objects on the respective user interface.

In some embodiments, a non-transitory computer-readable storage medium storing one or more programs configured to be executed by one or more processors of a computer system that is in communication with a display component, one or more input devices, and a physical input mechanism is described. In some embodiments, the one or more programs includes instructions for: while displaying a respective user interface, detecting, via the one or more inputs devices, an intent to control the physical input mechanism; in response to detecting the intent to control the physical input mechanism, displaying, via the display component, one or more user interface objects on the respective user interface, wherein movement of the physical input mechanism causes the computer system to update display at least one of the one or more user interface objects; and while displaying the one or more respective user interface objects on the respective user interface: in accordance with a determination that the physical input mechanism is not moving, the intent to control the physical input mechanism continues to be detected, and a predetermined period of time has not passed, continuing to display the one or more respective user interface objects on the respective user interface; in accordance with a determination that the physical input mechanism is not moving, the intent to control the physical input mechanism continues to be detected, and a predetermined period of time has passed, ceasing to display the one or more respective user interface objects on the respective user interface; and in accordance with a determination that the physical input mechanism is not moving and the intent to control the physical input mechanism does not continue to be detected, ceasing to display the one or more respective user interface objects on the respective user interface.

In some embodiments, a transitory computer-readable storage medium storing one or more programs configured to be executed by one or more processors of a computer system that is in communication with a display component, one or more input devices, and a physical input mechanism is described. In some embodiments, the one or more programs includes instructions for: while displaying a respective user interface, detecting, via the one or more inputs devices, an intent to control the physical input mechanism; in response to detecting the intent to control the physical input mechanism, displaying, via the display component, one or more user interface objects on the respective user interface, wherein movement of the physical input mechanism causes the computer system to update display at least one of the one or more user interface objects; and while displaying the one or more respective user interface objects on the respective user interface: in accordance with a determination that the physical input mechanism is not moving, the intent to control the physical input mechanism continues to be detected, and a predetermined period of time has not passed, continuing to display the one or more respective user interface objects on the respective user interface; in accordance with a determination that the physical input mechanism is not moving, the intent to control the physical input mechanism continues to be detected, and a predetermined period of time has passed, ceasing to display the one or more respective user interface objects on the respective user interface; and in accordance with a determination that the physical input mechanism is not moving and the intent to control the physical input mechanism does not continue to be detected, ceasing to display the one or more respective user interface objects on the respective user interface.

In some embodiments, a computer system that is in communication with a display component, one or more input devices, and a physical input mechanism is described. In some embodiments, the computer system that is in communication with a display component, one or more input devices, and a physical input mechanism comprises one or more processors and memory storing one or more programs configured to be executed by the one or more processors. In some embodiments, the one or more programs includes instructions for: while displaying a respective user interface, detecting, via the one or more inputs devices, an intent to control the physical input mechanism; in response to detecting the intent to control the physical input mechanism, displaying, via the display component, one or more user interface objects on the respective user interface, wherein movement of the physical input mechanism causes the computer system to update display at least one of the one or more user interface objects; and while displaying the one or more respective user interface objects on the respective user interface: in accordance with a determination that the physical input mechanism is not moving, the intent to control the physical input mechanism continues to be detected, and a predetermined period of time has not passed, continuing to display the one or more respective user interface objects on the respective user interface; in accordance with a determination that the physical input mechanism is not moving, the intent to control the physical input mechanism continues to be detected, and a predetermined period of time has passed, ceasing to display the one or more respective user interface objects on the respective user interface; and in accordance with a determination that the physical input mechanism is not moving and the intent to control the physical input mechanism does not continue to be detected, ceasing to display the one or more respective user interface objects on the respective user interface.

In some embodiments, a computer system that is in communication with a display component, one or more input devices, and a physical input mechanism is described. In some embodiments, the computer system that is in communication with a display component, one or more input devices, and a physical input mechanism comprises means for performing each of the following steps: while displaying a respective user interface, detecting, via the one or more inputs devices, an intent to control the physical input mechanism; in response to detecting the intent to control the physical input mechanism, displaying, via the display component, one or more user interface objects on the respective user interface, wherein movement of the physical input mechanism causes the computer system to update display at least one of the one or more user interface objects; and while displaying the one or more respective user interface objects on the respective user interface: in accordance with a determination that the physical input mechanism is not moving, the intent to control the physical input mechanism continues to be detected, and a predetermined period of time has not passed, continuing to display the one or more respective user interface objects on the respective user interface; in accordance with a determination that the physical input mechanism is not moving, the intent to control the physical input mechanism continues to be detected, and a predetermined period of time has passed, ceasing to display the one or more respective user interface objects on the respective user interface; and in accordance with a determination that the physical input mechanism is not moving and the intent to control the physical input mechanism does not continue to be detected, ceasing to display the one or more respective user interface objects on the respective user interface.

In some embodiments, a computer program product is described. In some embodiments, the computer program product comprises one or more programs configured to be executed by one or more processors of a computer system that is in communication with a display component, one or more input devices, and a physical input mechanism. In some embodiments, the one or more programs include instructions for: while displaying a respective user interface, detecting, via the one or more inputs devices, an intent to control the physical input mechanism; in response to detecting the intent to control the physical input mechanism, displaying, via the display component, one or more user interface objects on the respective user interface, wherein movement of the physical input mechanism causes the computer system to update display at least one of the one or more user interface objects; and while displaying the one or more respective user interface objects on the respective user interface: in accordance with a determination that the physical input mechanism is not moving, the intent to control the physical input mechanism continues to be detected, and a predetermined period of time has not passed, continuing to display the one or more respective user interface objects on the respective user interface; in accordance with a determination that the physical input mechanism is not moving, the intent to control the physical input mechanism continues to be detected, and a predetermined period of time has passed, ceasing to display the one or more respective user interface objects on the respective user interface; and in accordance with a determination that the physical input mechanism is not moving and the intent to control the physical input mechanism does not continue to be detected, ceasing to display the one or more respective user interface objects on the respective user interface.

In some examples, a method that is performed at a computer system that is in communication with a display component and one or more input devices is described. In some embodiments, the method comprises: displaying, via the display component, a visual representation of a value of a setting, wherein the visual representation includes a first visual property and a second visual property that are displayed based on the value of the setting, and wherein the first visual property is different from the second visual property; while displaying the visual representation including the first visual property and the second visual property, detecting, via the one or more input devices, a respective input; and in response to detecting the respective input: in accordance with the setting being a first type of setting and the respective input being in a first direction, changing the first visual property of the visual representation in a first manner without changing the second visual property of the visual representation; in accordance with the setting being the first type of setting and the respective input being in a second direction that is different from the first direction, changing the first visual property of the visual representation in a second manner without changing the second visual property of the visual representation, wherein the first manner is different from the second manner; in accordance with the setting being a second type of setting that is different from the first type of setting and the respective input being in the first direction, changing the first visual property of the visual representation in the first manner without changing the second visual property of the visual representation; and in accordance with the setting being the second type of setting and the respective input being in the second direction, changing the first visual property of the visual representation in the second manner and changing the second visual property of the visual representation in a third manner that is different from the first manner and the second manner.

In some embodiments, a non-transitory computer-readable storage medium storing one or more programs configured to be executed by one or more processors of a computer system that is in communication with a display component and one or more input devices is described. In some embodiments, the one or more programs includes instructions for: displaying, via the display component, a visual representation of a value of a setting, wherein the visual representation includes a first visual property and a second visual property that are displayed based on the value of the setting, and wherein the first visual property is different from the second visual property; while displaying the visual representation including the first visual property and the second visual property, detecting, via the one or more input devices, a respective input; and in response to detecting the respective input: in accordance with the setting being a first type of setting and the respective input being in a first direction, changing the first visual property of the visual representation in a first manner without changing the second visual property of the visual representation; in accordance with the setting being the first type of setting and the respective input being in a second direction that is different from the first direction, changing the first visual property of the visual representation in a second manner without changing the second visual property of the visual representation, wherein the first manner is different from the second manner; in accordance with the setting being a second type of setting that is different from the first type of setting and the respective input being in the first direction, changing the first visual property of the visual representation in the first manner without changing the second visual property of the visual representation; and in accordance with the setting being the second type of setting and the respective input being in the second direction, changing the first visual property of the visual representation in the second manner and changing the second visual property of the visual representation in a third manner that is different from the first manner and the second manner.

In some embodiments, a transitory computer-readable storage medium storing one or more programs configured to be executed by one or more processors of a computer system that is in communication with a display component and one or more input devices is described. In some embodiments, the one or more programs includes instructions for: displaying, via the display component, a visual representation of a value of a setting, wherein the visual representation includes a first visual property and a second visual property that are displayed based on the value of the setting, and wherein the first visual property is different from the second visual property; while displaying the visual representation including the first visual property and the second visual property, detecting, via the one or more input devices, a respective input; and in response to detecting the respective input: in accordance with the setting being a first type of setting and the respective input being in a first direction, changing the first visual property of the visual representation in a first manner without changing the second visual property of the visual representation; in accordance with the setting being the first type of setting and the respective input being in a second direction that is different from the first direction, changing the first visual property of the visual representation in a second manner without changing the second visual property of the visual representation, wherein the first manner is different from the second manner; in accordance with the setting being a second type of setting that is different from the first type of setting and the respective input being in the first direction, changing the first visual property of the visual representation in the first manner without changing the second visual property of the visual representation; and in accordance with the setting being the second type of setting and the respective input being in the second direction, changing the first visual property of the visual representation in the second manner and changing the second visual property of the visual representation in a third manner that is different from the first manner and the second manner.

In some embodiments, a computer system that is in communication with a display component and one or more input devices is described. In some embodiments, the computer system that is in communication with a display component and one or more input devices comprises one or more processors and memory storing one or more programs configured to be executed by the one or more processors. In some embodiments, the one or more programs includes instructions for: displaying, via the display component, a visual representation of a value of a setting, wherein the visual representation includes a first visual property and a second visual property that are displayed based on the value of the setting, and wherein the first visual property is different from the second visual property; while displaying the visual representation including the first visual property and the second visual property, detecting, via the one or more input devices, a respective input; and in response to detecting the respective input: in accordance with the setting being a first type of setting and the respective input being in a first direction, changing the first visual property of the visual representation in a first manner without changing the second visual property of the visual representation; in accordance with the setting being the first type of setting and the respective input being in a second direction that is different from the first direction, changing the first visual property of the visual representation in a second manner without changing the second visual property of the visual representation, wherein the first manner is different from the second manner; in accordance with the setting being a second type of setting that is different from the first type of setting and the respective input being in the first direction, changing the first visual property of the visual representation in the first manner without changing the second visual property of the visual representation; and in accordance with the setting being the second type of setting and the respective input being in the second direction, changing the first visual property of the visual representation in the second manner and changing the second visual property of the visual representation in a third manner that is different from the first manner and the second manner.

In some embodiments, a computer system that is in communication with a display component and one or more input devices is described. In some embodiments, the computer system that is in communication with a display component and one or more input devices comprises means for performing each of the following steps: displaying, via the display component, a visual representation of a value of a setting, wherein the visual representation includes a first visual property and a second visual property that are displayed based on the value of the setting, and wherein the first visual property is different from the second visual property; while displaying the visual representation including the first visual property and the second visual property, detecting, via the one or more input devices, a respective input; and in response to detecting the respective input: in accordance with the setting being a first type of setting and the respective input being in a first direction, changing the first visual property of the visual representation in a first manner without changing the second visual property of the visual representation; in accordance with the setting being the first type of setting and the respective input being in a second direction that is different from the first direction, changing the first visual property of the visual representation in a second manner without changing the second visual property of the visual representation, wherein the first manner is different from the second manner; in accordance with the setting being a second type of setting that is different from the first type of setting and the respective input being in the first direction, changing the first visual property of the visual representation in the first manner without changing the second visual property of the visual representation; and in accordance with the setting being the second type of setting and the respective input being in the second direction, changing the first visual property of the visual representation in the second manner and changing the second visual property of the visual representation in a third manner that is different from the first manner and the second manner.

In some embodiments, a computer program product is described. In some embodiments, the computer program product comprises one or more programs configured to be executed by one or more processors of a computer system that is in communication with a display component and one or more input devices. In some embodiments, the one or more programs include instructions for: displaying, via the display component, a visual representation of a value of a setting, wherein the visual representation includes a first visual property and a second visual property that are displayed based on the value of the setting, and wherein the first visual property is different from the second visual property; while displaying the visual representation including the first visual property and the second visual property, detecting, via the one or more input devices, a respective input; and in response to detecting the respective input: in accordance with the setting being a first type of setting and the respective input being in a first direction, changing the first visual property of the visual representation in a first manner without changing the second visual property of the visual representation; in accordance with the setting being the first type of setting and the respective input being in a second direction that is different from the first direction, changing the first visual property of the visual representation in a second manner without changing the second visual property of the visual representation, wherein the first manner is different from the second manner; in accordance with the setting being a second type of setting that is different from the first type of setting and the respective input being in the first direction, changing the first visual property of the visual representation in the first manner without changing the second visual property of the visual representation; and in accordance with the setting being the second type of setting and the respective input being in the second direction, changing the first visual property of the visual representation in the second manner and changing the second visual property of the visual representation in a third manner that is different from the first manner and the second manner.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for displaying controls, thereby increasing the effectiveness, efficiency, and user satisfaction with such devices. Such methods and interfaces may complement or replace other methods for displaying controls.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a system with various components in accordance with some embodiments.

FIGS. 2A-2E illustrate exemplary user interfaces for displaying controls in accordance with some embodiments.

FIGS. 3A-3B is a flow diagram illustrating a method for displaying controls in accordance with some embodiments.

FIGS. 4A-4F illustrate exemplary user interfaces for controlling the display of controls in accordance with some embodiments.

FIGS. 5A-5B is a flow diagram illustrating a method for controlling the display of controls in accordance with some embodiments.

FIGS. 6A-6G illustrate exemplary user interfaces for changing the appearance of a user interface object in accordance with some embodiments.

FIGS. 7A-7B is a flow diagram illustrating a method for changing the appearance of a user interface object in accordance with some embodiments.

### DETAILED DESCRIPTION

The following description sets forth exemplary techniques for displaying controls. This description is not intended to limit the scope of this disclosure but is instead provided as a description of example implementations.

Users need electronic devices that provide effective techniques for displaying controls. Efficient techniques can reduce a user's mental load when displaying controls. This reduction in mental load can enhance user productivity and make the device easier to use. In some embodiments, the techniques described herein can reduce battery usage and processing time (e.g., by providing user interfaces that require fewer user inputs to operate).

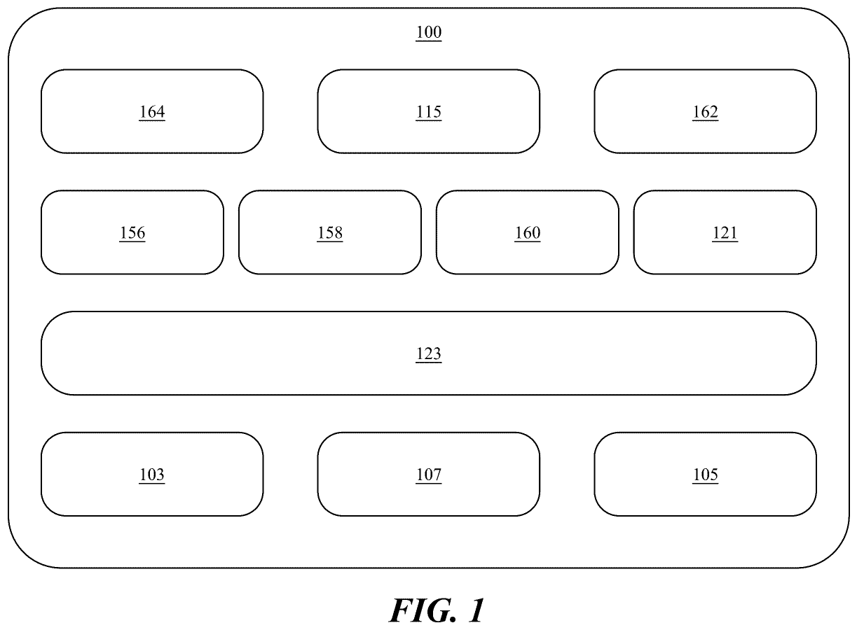

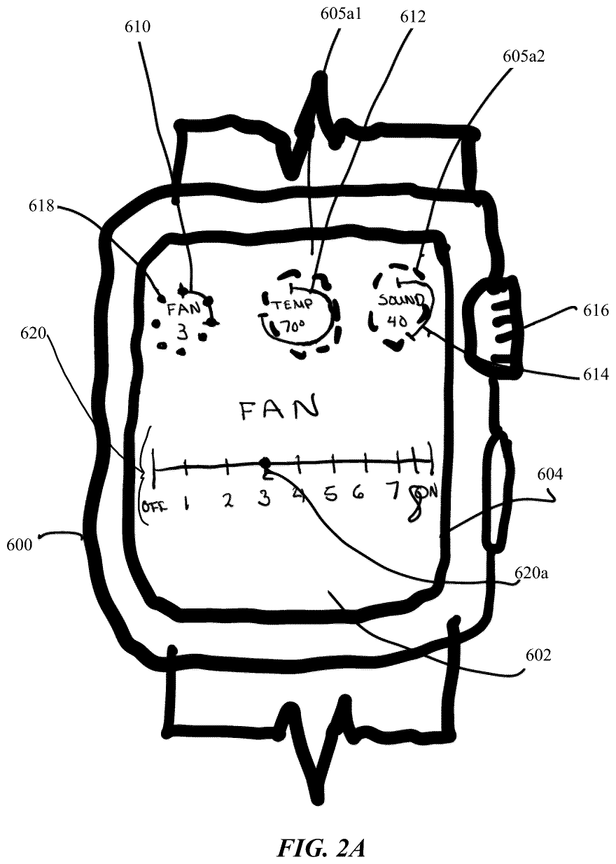

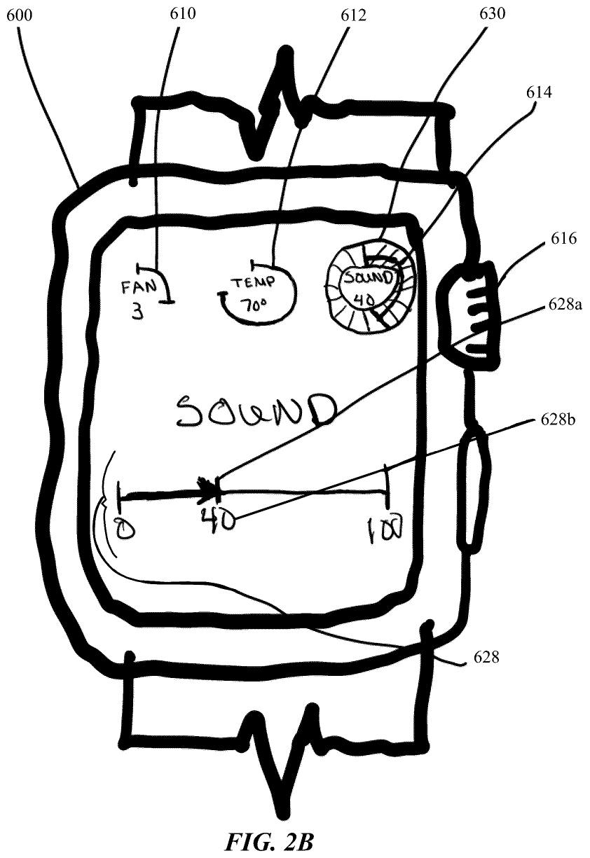

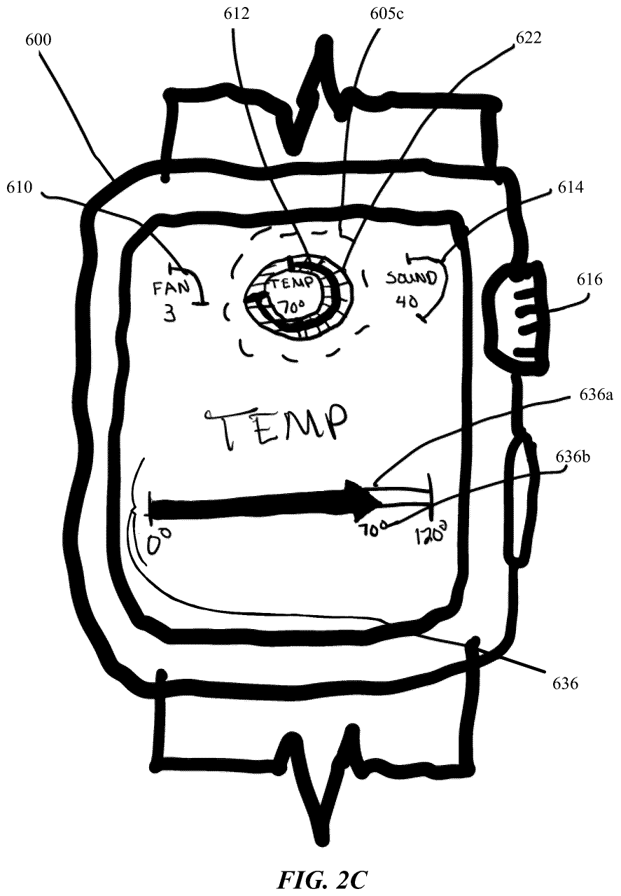

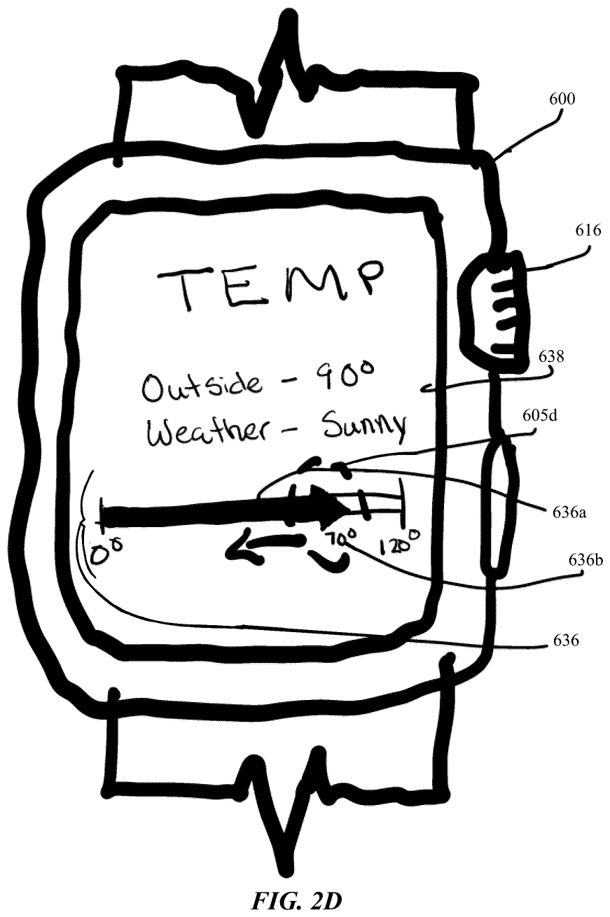

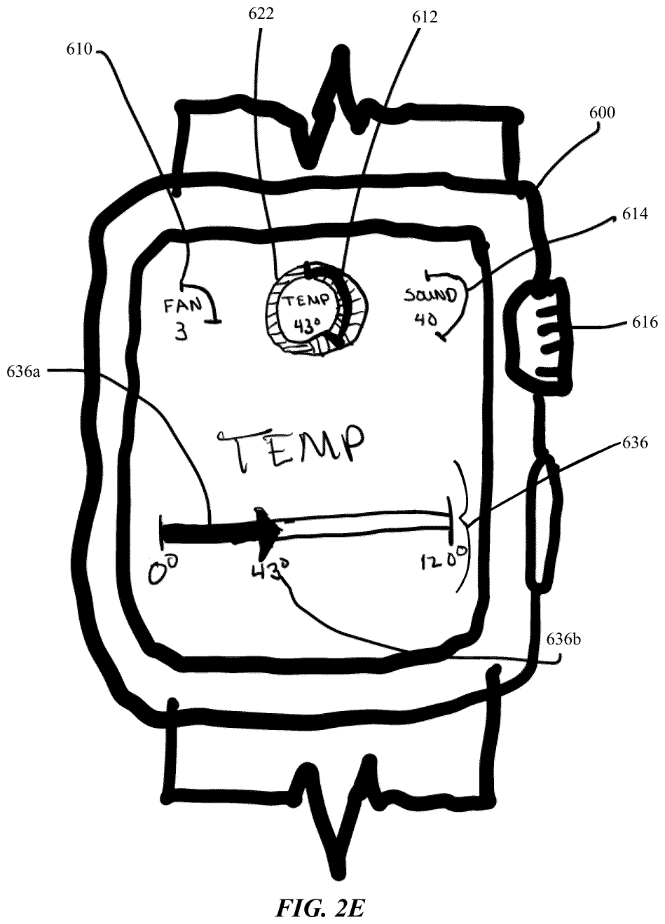

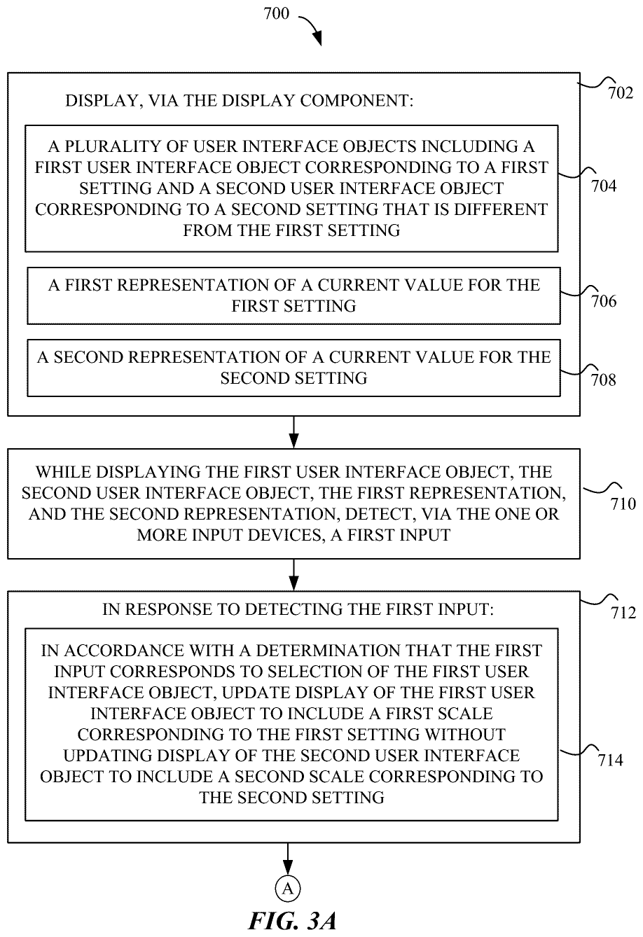

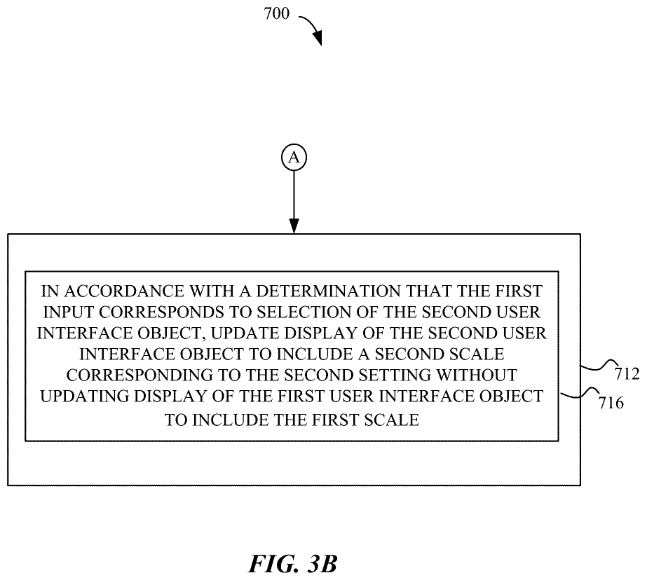

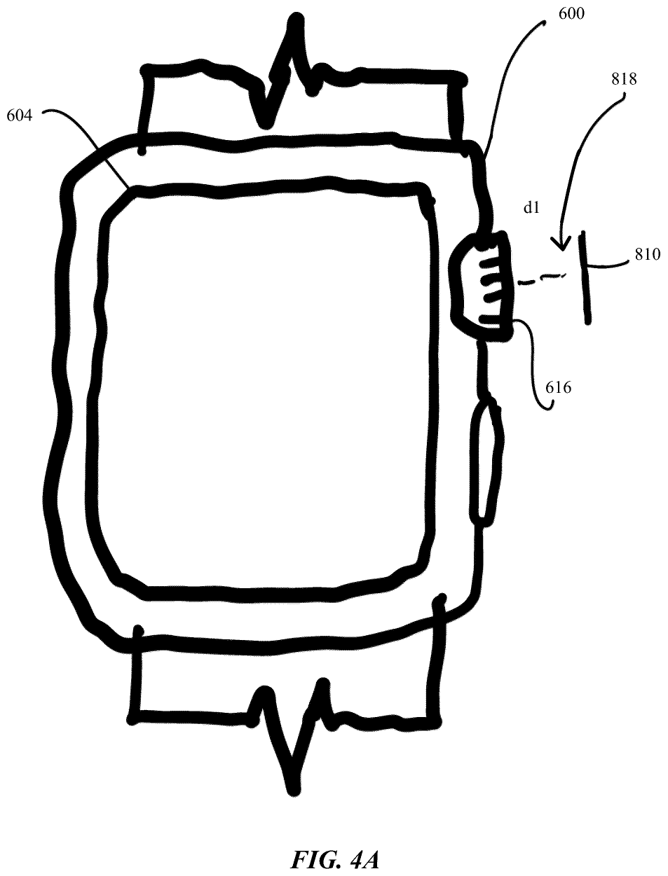

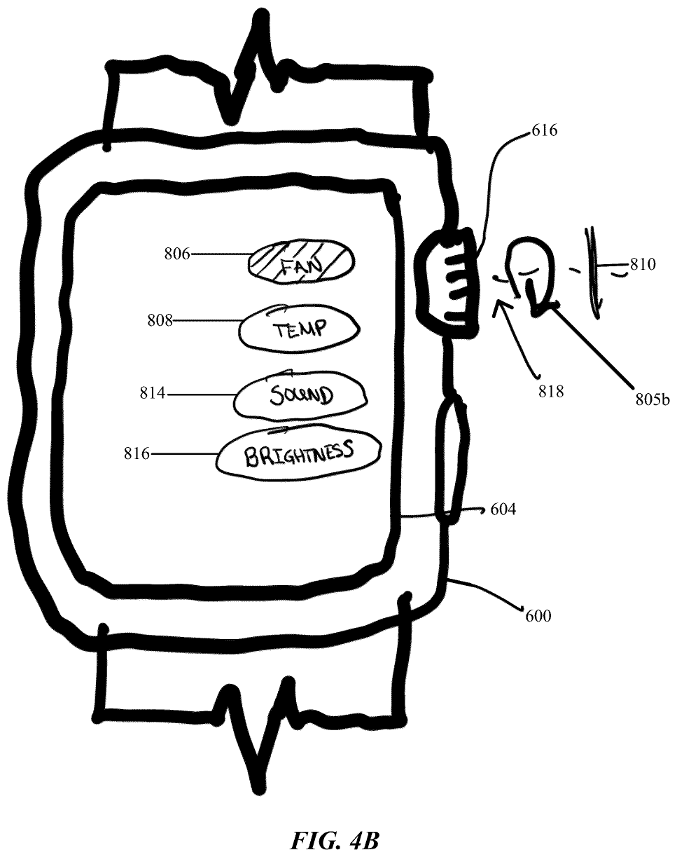

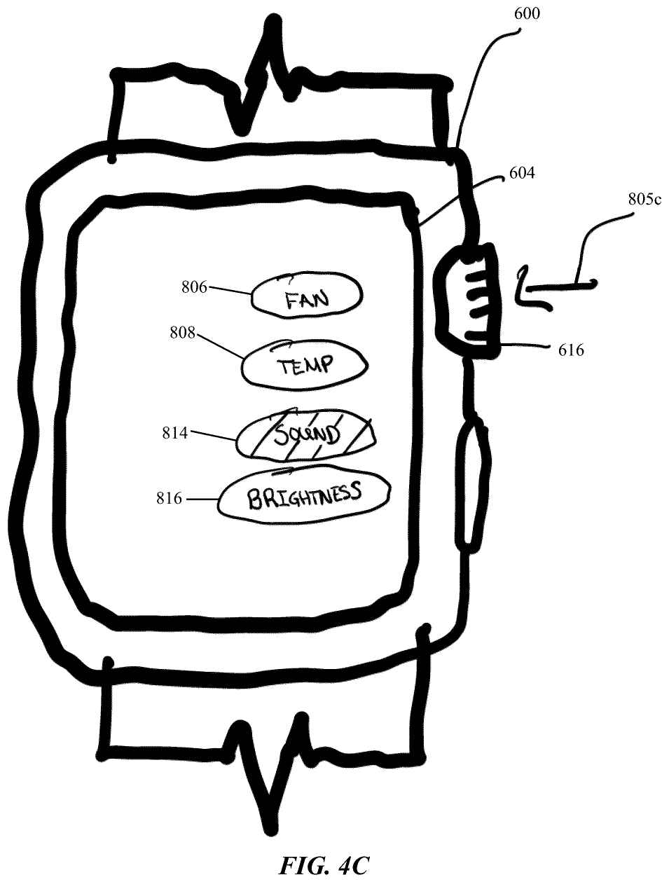

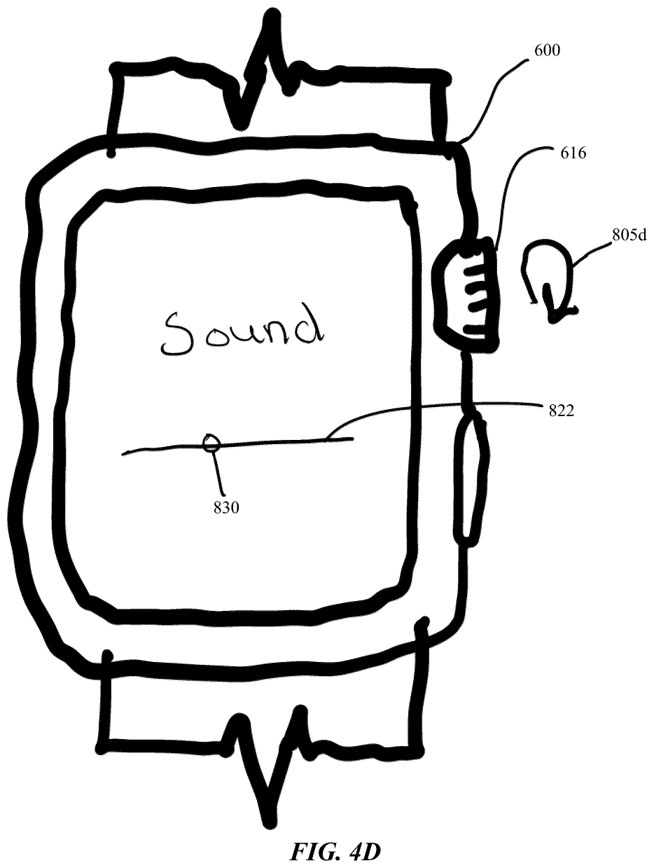

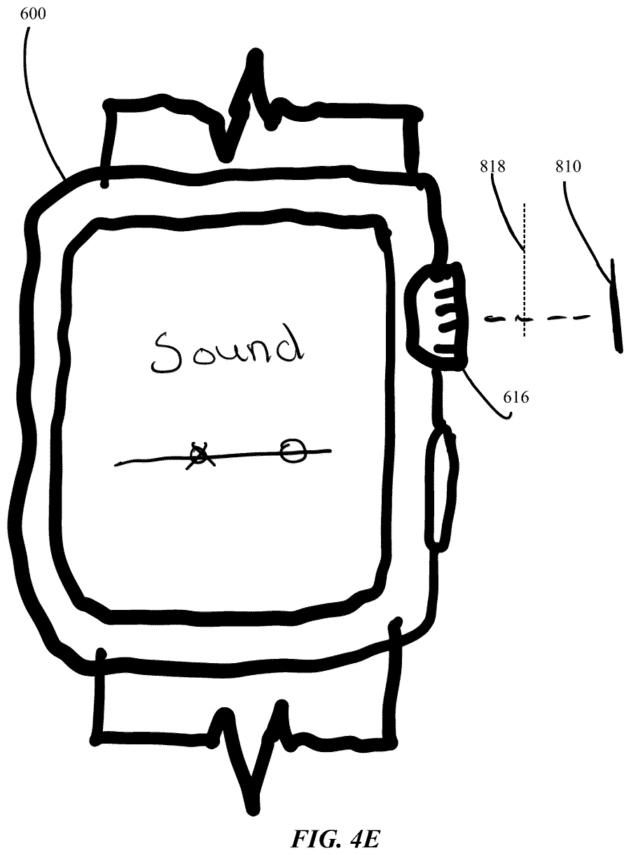

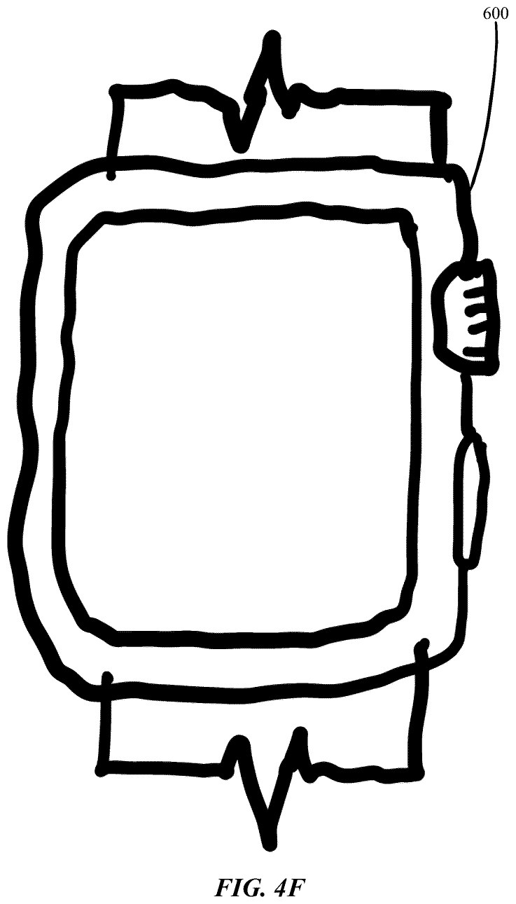

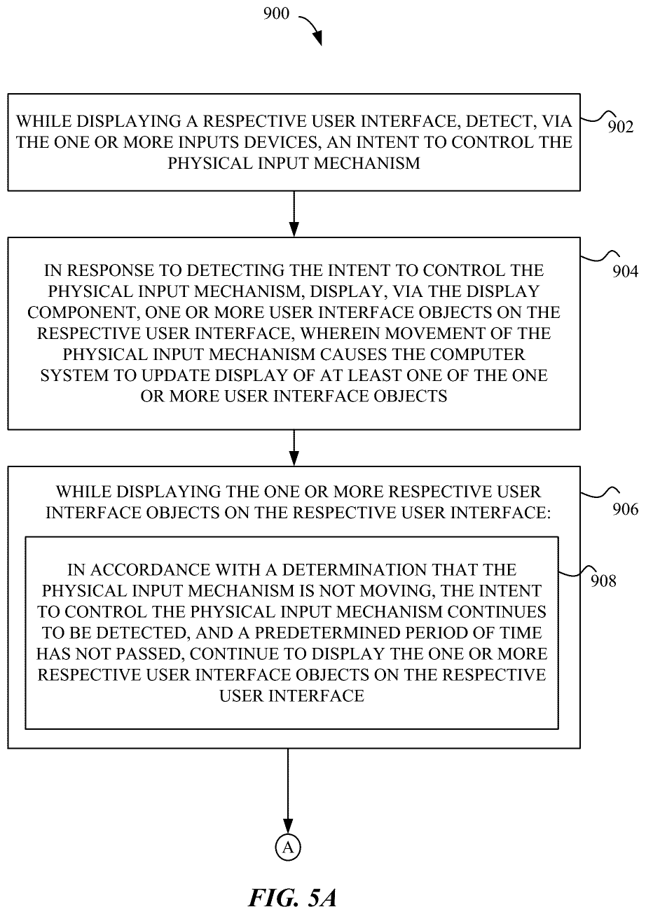

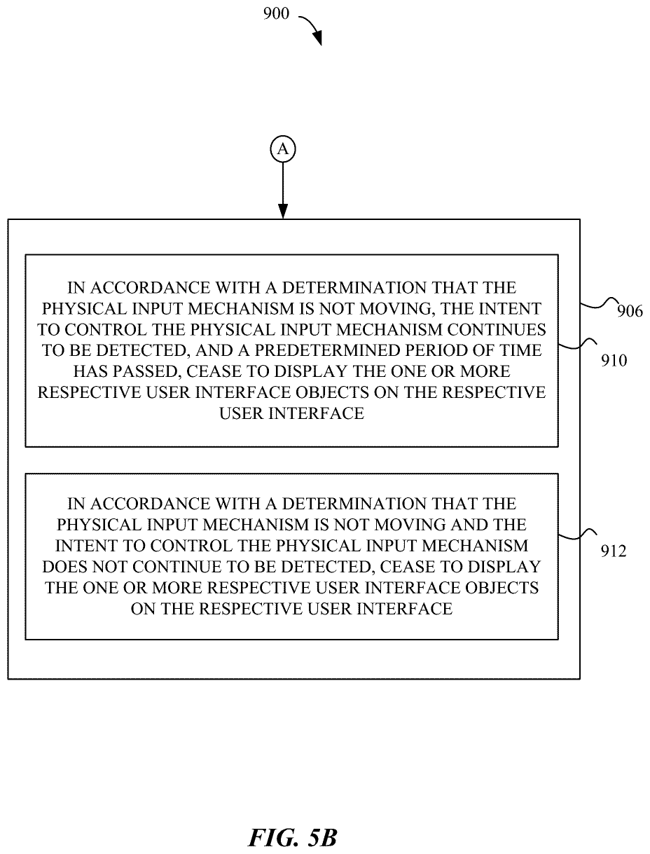

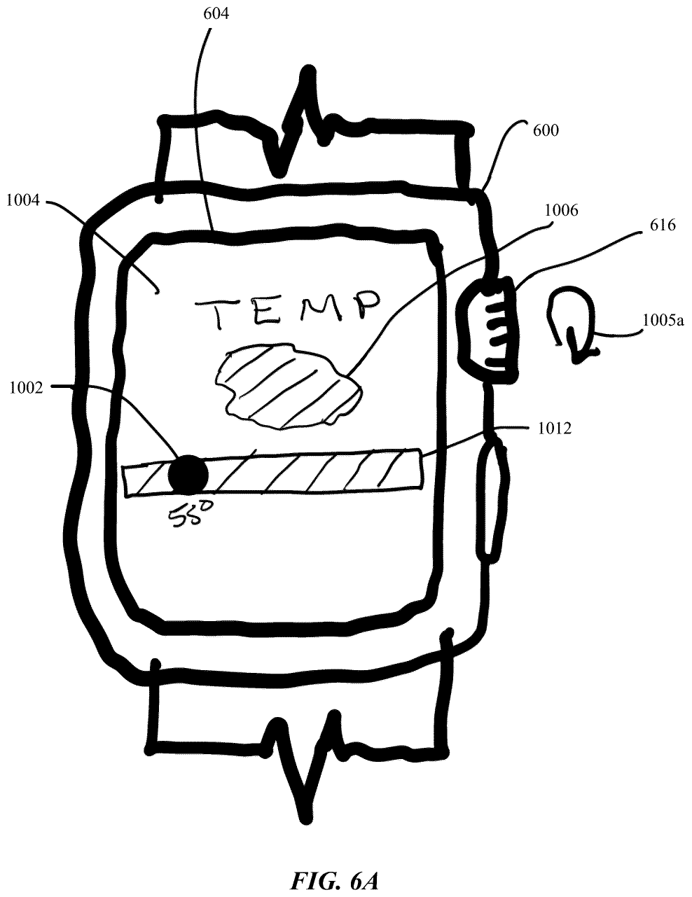

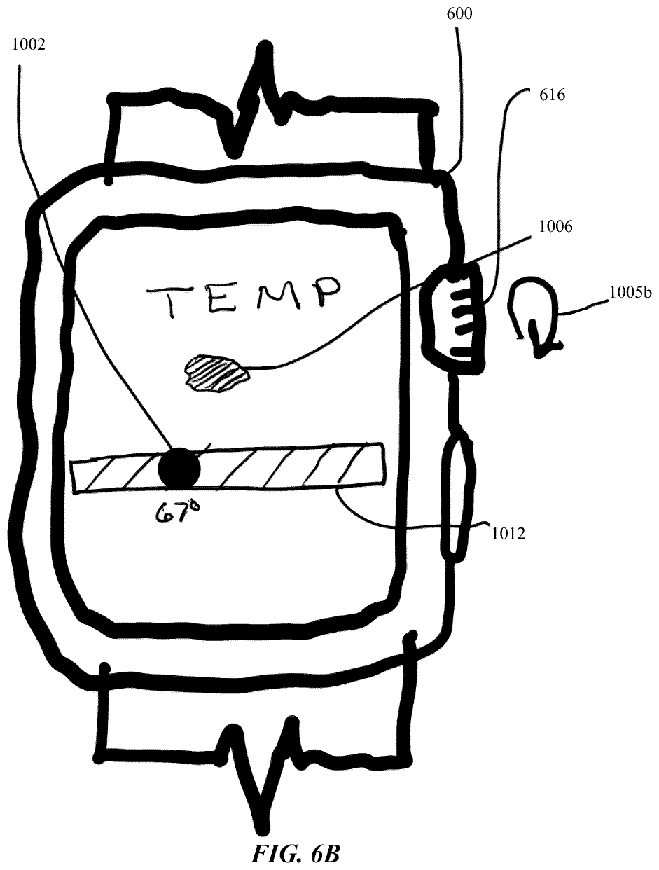

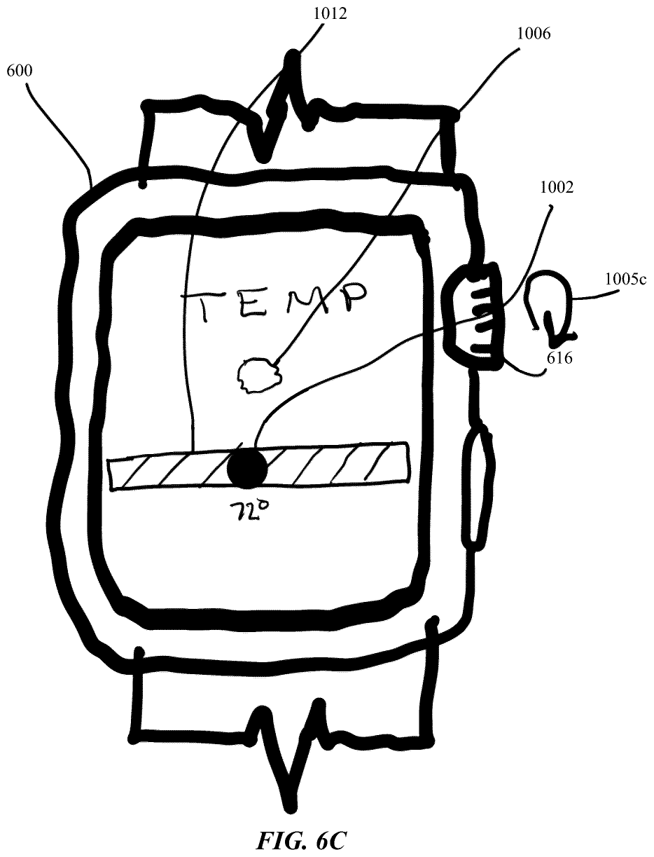

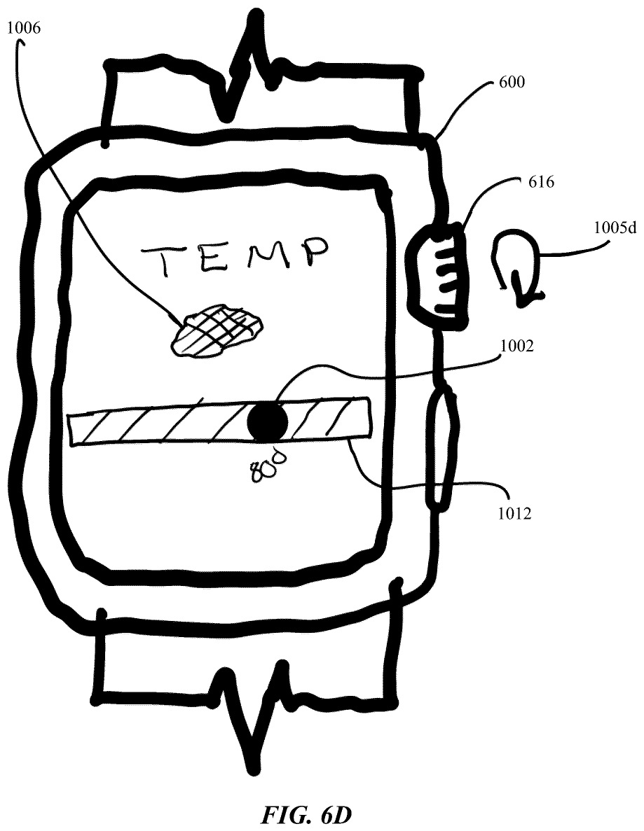

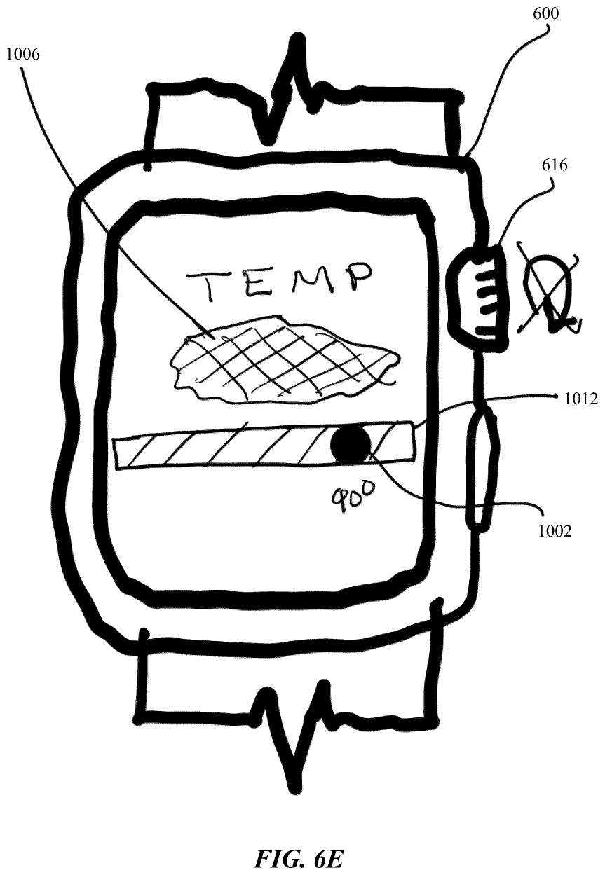

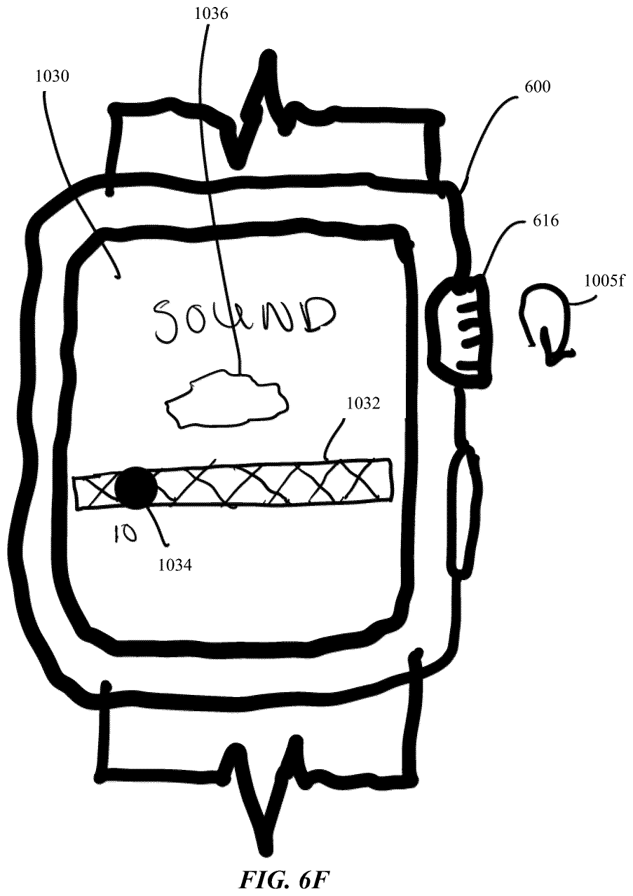

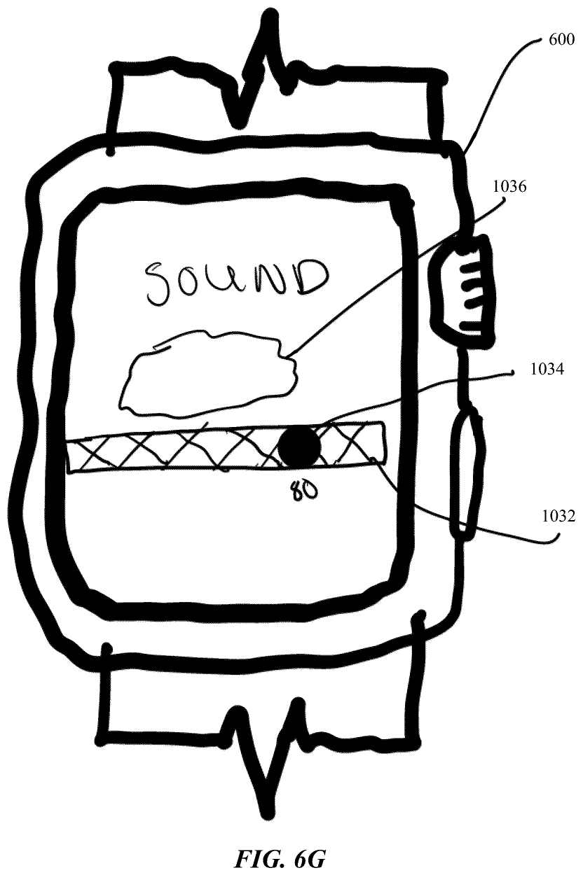

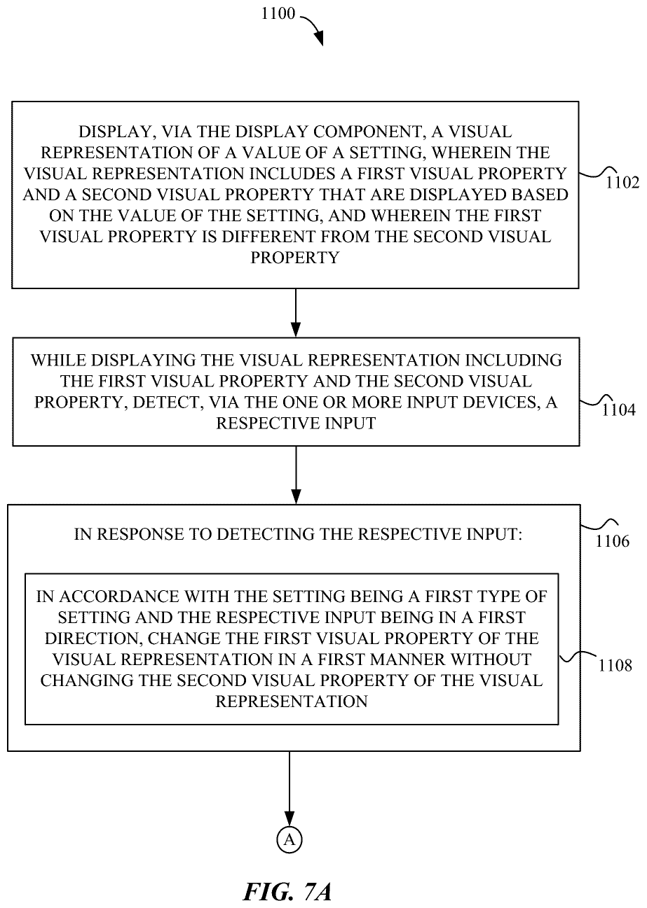

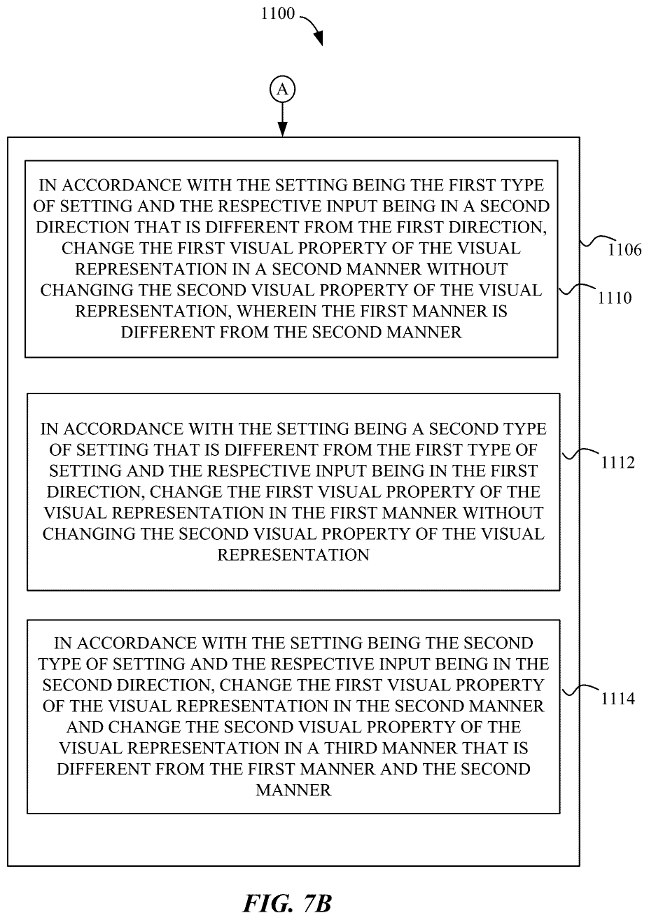

FIG. 1 provides illustrations of exemplary devices for performing techniques for displaying controls. FIGS. 2A-2E illustrate exemplary user interfaces for displaying in accordance with some embodiments. FIGS. 3A-3B is a flow diagram illustrating methods of displaying controls in accordance with some embodiments. The user interfaces in FIGS. 2A-2E are used to illustrate the processes described below, including the processes in FIGS. 3A-3B. FIGS. 4A-4F illustrate exemplary user interfaces for controlling the display of controls in accordance with some embodiments. FIGS. 5A-5B is a flow diagram illustrating methods of controlling the display of controls in accordance with some embodiments. The user interfaces in FIGS. 4A-4F are used to illustrate the processes described below, including the processes in FIGS. 5A-5B. FIGS. 6A-6G illustrate exemplary user interfaces for changing the appearance of a user interface object in accordance with some embodiments. FIGS. 7A-7B is a flow diagram illustrating a method for changing the appearance of a user interface object in accordance with some embodiments. The user interfaces in FIGS. 6A-6G are used to illustrate the processes described below, including the processes in FIGS. 7A-7B.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 1 illustrates an example system 100 for implementing techniques described herein. System 100 can perform any of the methods described in FIGS. 3, 5, and/or 7 (e.g., processes 700, 900, and/or 1100) and/or portions of these methods.

In FIG. 1, system 100 includes various components, such as processor(s) 103, RF circuitry(ies) 105, memory(ies) 107, sensors 156 (e.g., image sensor(s), orientation sensor(s), location sensor(s), heart rate monitor(s), temperature sensor(s)), input device(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output device(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input device.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 103 includes one or more general processors, one or more graphics processors, and/or one or more digital signal processors. In some embodiments, memory(ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry(ies) 105 includes circuitry for communicating with electronic devices and/or networks (e.g., the Internet, intranets, and/or a wireless network, such as cellular networks and wireless local area networks (LANs)). In some embodiments, RF circuitry(ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform 150. For example, system 100 uses orientation sensors to track changes in the location and/or orientation (sometimes collectively referred to as position) of system 100, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform 150. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100 and/or sensors that are on an exterior of system 100. In some embodiments, system 100 uses sensor(s) 156 (e.g., interior sensors) to detect a presence and/or state (e.g., location and/or orientation) of a passenger in the interior portion of system 100. In some embodiments, system 100 uses sensor(s) 156 (e.g., external sensors) to detect a presence and/or state of an object external to system 100. In some embodiments, system 100 uses sensor(s) 156 to receive user inputs, such as hand gestures and/or other air gesture. In some embodiments, system 100 uses sensor(s) 156 to detect the location and/or orientation of system 100 in the physical environment. In some embodiments, system 100 uses sensor(s) 156 to navigate system 100 along a planned route, around obstacles, and/or to a destination location. In some embodiments, sensor(s) 156 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100. In some embodiments, input device(s) 158 include one or more input devices (e.g., a touch-sensitive surface and/or keypad) on an exterior of system 100.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environment controls 162 includes mechanical and/or electrical systems for monitoring and/or controlling conditions of an internal portion (e.g., cabin) of system 100. In some embodiments, environmental controls 162 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery(ies)), transmission(s), suspension system(s), speed control system(s), and/or steering system(s). In some embodiments, one or more elements of mobility component(s) are configured to be controlled autonomously or manually (e.g., via system 100 and/or input device(s) 158).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry(ies) 105.

In some embodiments, system 100 is capable of communicating with other computer systems and/or electronic devices. For example, system 100 can use RF circuitry(ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 156 to be transmitted to the other system(s) in the videoconferencing communication sessions using RF circuitry(ies) 105. In some embodiments, system 100 receives, using the RF circuitry(ies) 105, video and/or audio from the other system(s) in the videoconferencing communication sessions, and presents the video and/or audio using output device(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output device(s) 160. In some embodiments, output device(s) 160 generates the tactile outputs by displacing a moveable mass relative to a neutral position. In some embodiments, tactile outputs are periodic in nature, optionally including frequency(ies) and/or amplitude(s) of movement in two or three dimensions. In some embodiments, system 100 generates a variety of different tactile outputs differing in frequency(ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency(ies) corresponds to faster movement(s) by the moveable mass whereas lower frequency(ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input device(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input device(s) 158 to detect the user speaking one or more words. In some embodiments, system 100 parses and/or communicates information to one or more other systems to determine contents of the speech of the user, including identifying words and/or obtaining a semantic understanding of the words. For example, system processor(s) 103 can be configured to perform natural language processing to detect one or more words and/or determine a likely meaning of the one or more words in the sequence spoken by the user. Additionally or alternatively, in some embodiments, the system 100 determines the meaning of the one or more words in the sequence spoken based upon a context of the user determined by the system 100.

In some embodiments, system 100 outputs spatial audio via output device(s) 160. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry(ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as the system 100 functioning as a key to initiate operation of an actuation system of a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry(ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

Attention is now directed towards embodiments of user interfaces (“UI”) and associated processes that are implemented on an electronic device, such as system 100.

FIGS. 2A-2E illustrate exemplary user interfaces for displaying controls in accordance with some embodiments. The user interfaces in these figures are used to illustrate the processes described below, including the processes in FIGS. 3A-3B.

FIG. 2A illustrates computer system 600. As illustrated in FIG. 2A, computer system 600 is a smartwatch and includes display 604 (e.g., a display component) and rotatable input mechanism 616. However, it should be understood that the types of computer systems and components described herein are merely exemplary and are provided to give context to the embodiments described herein. In some embodiments, computer system 600 includes a knob, a dial, a joystick, a touch-sensitive surface, a button, a slider, a television, a projector, a monitor, a smart display, a laptop, and/or a personal computer. In some embodiments, display 604 is positioned within rotatable input mechanism 616. In some embodiments, display 604 is positioned above or below rotatable input mechanism 616. In some embodiments, display 604 is positioned around rotatable input mechanism 616. In some embodiments, rotatable input mechanism 616 is positioned on the surface of display 604.

As illustrated in FIG. 2A, computer system 600 displays controls user interface 602. At FIG. 2A, controls user interface 602 includes fan value user interface object 610, temperature value user interface object 612, and volume value user interface object 614. Fan value user interface object 610 corresponds to a fan device, temperature value user interface object 612 corresponds to an air conditioning device (e.g., a device that is capable of heating and cooling a space), and volume value user interface object 614 corresponds to one or more speaker devices. In some embodiments, computer system 600, the fan device, the air conditioning device, and the one or more speaker devices are coupled to a common external structure (e.g., an airplane, car, bus, boat, and/or home). In some embodiments, the fan device, the air conditioning device, and the one or more speaker devices are integrated into computer system 600. In some embodiments, the fan device, the air conditioning device, and the one or more speaker devices are external to computer system 600. In some embodiments, computer system 600 displays fan value user interface object 610, temperature value user interface object 612, and volume value user interface object 614 around rotatable input mechanism 616.

Fan value user interface object 610 includes a numerical representation that indicates the current setting of the fan device (e.g., the output of the fan), temperature value user interface object 612 includes a numerical representation that indicates the current temperature setting of the air conditioning device, and volume value user interface object 614 includes a numerical representation of the volume level of the one or more speaker devices. As illustrated in FIG. 2A, fan value user interface object 610 indicates that the setting of the fan device is set to three, temperature value user interface object 612 indicates that the temperature setting of the air conditioning device is set to 70 degrees, and volume value user interface object 614 indicates that the one or more speaker devices are set to a volume level of forty.

Further, as illustrated in FIG. 2A, computer system 600 displays fan scale user interface object 618. Computer system 600 displays fan scale user interface object 618 as a series of dots that form a circle. Each dot in the series of dots corresponds to a respective fan level of the fan device. The number of dots that are connected indicates the current fan level of the fan device. As illustrated in FIG. 2A, computer system 600 displays fan scale user interface object 618 with three circles connected. Accordingly, at FIG. 2A, the fan device is operating at level 3.

As illustrated in FIG. 2A, computer system 600 displays fan value user interface object 610 as a smooth curve (e.g., an arc). The degree of the curve of fan value user interface object 610 corresponds to the fan setting of the fan device. The higher the value of the fan setting of the fan device, the larger the degree of the curve of fan value user interface object 610. This description of fan value user interface object is also applicable to temperature value user interface object 612 and volume value user interface object 614. In some embodiments, in response to computer system 600 detecting a rotation of rotatable input mechanism 616 while computer system 600 displays fan scale user interface object 618, computer system 600 transmits instructions to the fan device that cause the operation of the fan device to adjust. In embodiments where computer system 600 transmits instructions to the fan device that adjust the operation of the fan device, the power of the fan increases when computer system 600 detects that rotatable input mechanism 616 is rotated in a first direction (e.g., a clockwise direction) and the power of the fan decreases if computer system 600 detects that rotatable input mechanism 616 is rotated in a second direction (e.g., counterclockwise).

As illustrated in FIG. 2A, computer system 600 displays enlarged fan control user interface object 620 and fan value indicator 620a. Like fan value user interface object 610, enlarged fan control user interface object 620 corresponds to the fan device. Computer system 600 displays enlarged fan control user interface object 620 as a horizontal line graph with several tick marks. Each tick mark corresponds to a respective fan setting of the fan device. Fan value indicator 620a indicates the current fan setting of the fan device. At FIG. 2A, because the fan device is operating at the third fan level, computer system 600 displays fan value indicator 620a as overlaid on top of the tick mark that corresponds to the third fan setting.

At FIG. 2A, computer system 600 detects input 605a1 that corresponds to selection of temperature value user interface object 612 or computer system 600 detects input 605a2 that corresponds to selection of volume value user interface object 614. In some embodiments, computer system 600 displays enlarged fan control user interface object 620 in response to computer system 600 detecting an input that corresponds to selection of fan value user interface object 610. In some embodiments, inputs 605a2 and 605a1 correspond to a depression and/or rotation of rotatable input mechanism 616, voice command, swipe gesture, tap gesture, hand gesture and/or a gaze. In some embodiments, while computer system 600 displays enlarged fan control user interface object 620, computer system 600 outputs a continuous haptic output while computer system 600 detects an input that corresponds to a rotation of rotatable input mechanism 616. In some embodiments, computer system 600 outputs a single discrete haptic output in response to computer system 600 detecting input 605a1 and/or 605a2. In some embodiments, input 605a1 and/or input 605a2 is a rotation of rotatable input mechanism 616, depression of rotatable input mechanism 616, slide gesture, tap gesture, voice command, and/or gaze.

FIGS. 2B and 2C illustrate the behavior of computer system 600 in response to computer system 600 detecting input 605a1 or 605a2. More specifically, FIG. 2B illustrates the behavior of computer system 600 in response to computer system 600 detecting input 605a2 and FIG. 2C illustrates the behavior of computer system 600 in response to computer system 600 detecting input 605a1. Either FIG. 2B or FIG. 2C can follow FIG. 2A.

As illustrated in FIG. 2B, in response to computer system 600 detecting input 605a2, computer system 600 displays enlarged volume control user interface object 628 and ceases to display enlarged fan control user interface object 620 and fan scale user interface object 618. Enlarged volume control user interface object 628 corresponds to the one or more speaker devices (e.g., that correspond to volume value user interface object 614).

As illustrated in FIG. 2B, enlarged volume control user interface object 628 includes volume indicator 628a and numerical representation 628b. Volume indicator 628a and numerical representation 628b indicate the current volume level of the one or more speaker devices. Computer system 600 displays volume indicator 628a with a different appearance than fan value indicator 620a (e.g., as shown in FIG. 2A). That is, computer system 600 displays volume indicator 628a as an arrow and computer system 600 displays fan value indicator 620a as a dot.

Further, as illustrated in FIG. 2B, in response to computer system 600 detecting input 605a2, computer system 600 displays volume scale user interface object 630 around volume value user interface object 614. Volume scale user interface object 630 corresponds to the range of volume levels of the one or more speaker devices. Computer system 600 does not display a respective scale around fan value user interface object 610 and temperature value user interface object 612 while computer system 600 displays volume scale user interface object 630 around the display of volume value user interface object 614.

Computer system 600 displays volume scale user interface object 630 with a different visual appearance than fan scale user interface object 618 (e.g., computer system 600 displays fan scale user interface object 618 as a series of dots in a circle and computer system 600 displays volume scale user interface object 630 as a series of connected/adjacent quadrilaterals). In some embodiments, computer system 600 does not display enlarged volume control user interface object 628 in response to detecting input 605a1. In some embodiments, computer system 600 transmits instructions to the one or more speaker devices that modify the volume level of the one or more speaker devices in response to computer system 600 detecting an input (e.g., a slide gesture) that corresponds to selection of volume indicator 628a and/or numerical representation 628b. In some embodiments, while computer system 600 displays enlarged volume control user interface object 628, computer system 600 outputs a continuous haptic output while computer system 600 detects an input that corresponds to a rotation of rotatable input mechanism 616 (e.g., computer system 600 outputs a different type of haptic output in response to computer system 600 detecting a rotation of rotatable input mechanism 616 while computer system 600 displays enlarged fan control user interface object 620 than when computer system 600 detects an input that corresponds to a rotation of rotatable input mechanism 616 while computer system 600 displays enlarged volume control user interface object 628). In some embodiments, computer system 600 displays enlarged volume control user interface object 628 in response to computer system 600 detecting an input that corresponds to a selection of volume value user interface object 614 while computer system 600 displays volume scale user interface object 630.

FIG. 2C illustrates the behavior of computer system 600 in response to computer system 600 detecting input 605a1 at FIG. 2A. As explained above, either FIG. 2B or 2C can follow FIG. 2A.

As illustrated in FIG. 2C, in response to computer system 600 detecting input 605a1, computer system 600 displays temperature scale user interface object 622 around temperature value user interface object 612 and computer system 600 ceases to display enlarged fan control user interface object 620 and fan scale user interface object 618. Temperature scale user interface object 622 corresponds to the range of temperature settings of the air conditioning device. Computer system 600 does not display a respective scale around fan value user interface object 610 and volume value user interface object 614 while computer system 600 displays temperature scale user interface object 622 around temperature value user interface object 612. In some embodiments, computer system 600 displays temperature scale user interface object 622 with a number of colors that correspond to the various temperature settings (e.g., blue corresponds to cool temperature settings and red corresponds to warm temperature settings) of the air conditioning device.

Further, as illustrated in FIG. 2C, in response to computer system 600 detecting input 605a1, computer system 600 displays enlarged temperature control user interface object 636. Enlarged temperature control user interface object 636 corresponds to a range of temperature settings of the air conditioning device. As illustrated in FIG. 2C, as part of displaying enlarged temperature control user interface object 636, computer system 600 displays temperature indicator user interface object 636a and temperature numerical representation user interface object 636b. Temperature indicator user interface object 636a and temperature numerical representation user interface object 636b indicate the current temperature setting of the air conditioning device. Accordingly, at FIG. 2C, the air conditioning device is set to 70 degrees. In some embodiments, while computer system 600 displays enlarged temperature control user interface 636, in response to detecting a rotation of rotatable input mechanism 616, computer system 600 transmits instructions to the air conditioning device that adjusts the temperature setting of the air conditioning device.

At FIG. 2C, while computer system 600 displays temperature scale user interface object 622, computer system 600 detects input 605c that corresponds to selection of temperature value user interface object 612. In some embodiments, input 605c corresponds to tap gesture, swipe gesture, a rotation of rotatable input mechanism 616, depression of rotatable input mechanism 616, a voice command, a gaze, and/or hand gesture. In some embodiments, computer system 600 does not display enlarged temperature control user interface object 636 in response to detecting input 605a1. In some embodiments, enlarged temperature control user interface object 636 is not selectable (e.g., computer system 600 does not perform an action in response to detecting an input on the display of enlarged temperature control user interface object 636). In some embodiments, computer system 600 displays enlarged temperature control user interface object 636, enlarged sound control user interface object 628, and/or enlarged fan control user interface object 620 around rotatable input mechanism 616 such that a respective enlarged control surrounds a different amount of rotatable input mechanism (e.g., enlarged temperature control user interface object 636 surrounds half of rotatable input mechanism 616 and enlarged sound control user interface object 628 surrounds three-quarters of rotatable input mechanism 616).

At FIG. 2D, in response to detecting input 605c, computer system 600 ceases to display fan value user interface object 610, temperature value user interface object 612, temperature scale user interface object 622, and volume value user interface object 614. Further, as illustrated in FIG. 2D, in response to detecting input 605c, computer system 600 displays weather information 638. Weather information 638 indicates the current weather conditions (e.g., temperature, humidity, rain conditions, and/or cloud conditions) at the physical location of computer system 600.

As illustrated in FIG. 2D, in response to detecting input 605c, computer system 600 maintains the display of enlarged temperature control user interface object 636, temperature indicator user interface object 636a, and temperature numerical representation user interface object 636b. In some embodiments, computer system 600 displays enlarged temperature control user interface object 636, temperature indicator user interface object 636a, and temperature numerical representation user interface object 636b, in response to computer system 600 detecting input 605c. At FIG. 2D, computer system 600 detects input 605d that corresponds to a leftward swipe on the display of enlarged temperature control user interface object 636. In some embodiments, input 605d corresponds to tap gesture, swipe gesture, a rotation of rotatable input mechanism 616, depression of rotatable input mechanism 616, a voice command, a gaze, and/or hand gesture. In some embodiments, computer system 600 redisplays displays fan value user interface object 610, temperature value user interface object 612, temperature scale user interface object 622, and volume value user interface object 614 in response to detecting that rotatable input mechanism 616 is depressed.

At FIG. 2E, in response to detecting input 605d, computer system 600 transmits instructions to the air conditioning device that cause the air conditioning device to decrease its temperature setting to 43 degrees. That is, computer system 600 is configured to control the operation of the air conditioning device while computer system 600 displays enlarged temperature control user interface object 636 without displaying fan value user interface object 610, temperature value user interface object 612, temperature scale user interface object 622, and volume value user interface object 614. At FIG. 2E, in response to detecting input 605d, computer system 600 updates the display of temperature numerical representation user interface object 636b and temperature indicator user interface object 636a. Accordingly, as illustrated in FIG. 2E, both temperature numerical representation user interface object 636b and temperature indicator user interface object 636a indicate that the current temperature setting of the air conditioning device is 43 degrees. In some embodiments, computer system 600 is configured to control the operation of the air condition device while computer system 600 concurrently displays enlarged temperature control user interface object and one or more of fan value user interface object 610, temperature value user interface object 612, temperature scale user interface object 622, and/or volume value user interface object 614. In some embodiments, computer system 600 outputs a continuous haptic while computer system 600 detects input 605d.

At FIG. 2E, a determination is made that a predetermined amount of time (e.g., 3, 5, 7, 10, 15, 20, 25, or 30 seconds) has elapsed since computer system 600 detected input 605d. Because a determination is made that the predetermined amount of time has elapsed since computer system 600 has detected input 605d, as illustrated in FIG. 2E, computer system 600 displays fan value user interface object 610, temperature value user interface object 612, temperature scale user interface object 622, and volume value user interface object 614.

As illustrated in FIG. 2E, computer system 600 displays temperature value user interface object 612 with an indication of the new temperature setting of the air conditioning device. In some embodiments, computer system 600 displays fan value user interface object 610, temperature value user interface object 612, temperature scale user interface object 622, and volume value user interface object 614 in response to computer system 600 detecting input 605d. In some embodiments, rotatable input mechanism 616 includes a display. In embodiments where rotatable input mechanism 616 includes a display, computer system 600 changes the color of the display of rotatable input mechanism 616 in accordance with the change in the temperature setting of the air conditioning device (e.g., the display of rotatable input mechanism 616 changes from an orange color to a blue color to indicate that the temperature setting of the air conditioning device is getting cooler). In some embodiments, computer system 600 transmits instructions to the air conditioning device that cause the air conditioning device to increase its temperature setting in response to computer system 600 detecting an input that corresponds to a rightward swipe input on the display of enlarged temperature control user interface object 636. In some embodiments, computer system 600 transmits instructions to the air conditioning device that modify the temperature setting of the air conditioning device in response to detecting that rotatable input mechanism 616 is rotated (e.g., the temperature setting of the air conditioning device is increased if computer system 600 detects that rotatable input mechanism 616 is rotated in the clockwise direction and the temperature setting of the air conditioning device is decreased if computer system 600 detects that rotatable input mechanism 616 is rotated in the counter-clockwise direction). FIGS. 3A-3B is a flow diagram illustrating a method (e.g., process 700) for displaying controls in accordance with some embodiments. Some operations in process 700 are, optionally, combined, the orders of some operations are, optionally, changed, and some operations are, optionally, omitted.

As described below, process 700 provides an intuitive way for displaying controls. Process 700 reduces the cognitive burden on a user for displaying controls, thereby creating a more efficient human-machine interface. For battery-operated computing devices, enabling a user to display controls faster and more efficiently conserves power and increases the time between battery charges.

In some embodiments, process 700 is performed at a computer system (e.g., 600) that is in communication with a display component (e.g., 604) (e.g., a display screen and/or a touch-sensitive display) and one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

The computer system displays (702), via the display component (e.g., 604): (704) a plurality of user interface objects (e.g., 610, 612, and/or 614) (e.g., selectable user interface objects and/or user interface objects that, when selected, cause the computer system to perform an operation) (e.g., home and/or vehicle controls (e.g., temperature, volume, fan speed, and/or light intensity) and/or media controls (e.g., volume, playback speed, next track, previous track, fast forward, and/or rewind)) including a first user interface object (e.g., 610, 612, and/or 614) corresponding to a first setting (e.g., a media playback setting, a temperature setting, a volume setting, a fan speed setting, and/or a light intensity setting) and a second user interface object (e.g., 610, 612, and/or 614) corresponding to a second setting that is different from the first setting; a (706) first representation of a current value (e.g., a non-numerical representation (e.g., a scale and/or filling in a bar and/or line graph), a textual representation, and/or a numerical representation) for the first setting (e.g., as described above at FIG. 2A); and a (708) second representation of a current value (e.g., a non-numerical representation (e.g., a scale and/or filling in a bar and/or line graph), a textual representation, and/or a numerical representation) for the second setting (e.g., as described above at FIG. 2A). In some embodiments, the first representation of the current value for the first setting is visually different from the second representation of the current value for the second setting. In some embodiments, the first representation is located at a different location than the second representation. In some embodiments, the first user interface object includes the first representation of the current value. In some embodiments, the second user interface object includes the second representation of the current value.

While displaying the first user interface object (e.g., 610, 612, and/or 614), the second user interface object (e.g., 610, 612, and/or 614), the first representation, and the second representation (and, In some embodiments, the plurality of user interface objects), the computer system detects (710), via the one or more input devices, a first input (e.g., 605a1 and/or 605a2) (e.g., an input (e.g., a tap input and/or a rotational input) on a rotatable input mechanism and/or a tap on a control and/or user interface object) (and, In some embodiments, a non-tap input, such as a mouse click, gaze input, voice command, air gesture (e.g., a tap air gesture, a pinch gesture, and/or a flicking air gesture)).

In response to (712) detecting the first input (e.g., 605a1 and/or 605a2) and in accordance with a determination that the first input (e.g., 605a1 and/or 605a2) corresponds to selection of the first user interface object (e.g., 610, 612, and/or 614), the computer system updates (714) display of the first user interface object to include a first scale (e.g., 618, 622 and/or 630) (e.g., update the user interface object to have color which indicates a scale and/or a range of values) corresponding to the first setting (e.g., displaying an animation that gradually transitions display of the scale and/or fades in the scale) without updating display of the second user interface object (e.g., 610, 612, and/or 614) to include a second scale (e.g., 618, 622 and/or 630) corresponding to the second setting (e.g., and without updating the second user interface object to include the first scale). In some embodiments, the first scale is different from the first representation of the current value. In some embodiments, while the first scale is displayed, the first representation of the current value is overlaid on, on top of, and/or over the first scale.

In response to (712) detecting the first input and in accordance with a determination that the first input (e.g., 605a1 and/or 605a2) corresponds to selection of the second user interface object (e.g., 610, 612, and/or 614), the computer system updates (716) display of the second user interface object to include a second scale (e.g., 618, 622 and/or 630) corresponding to the second setting without updating display of the first user interface object (e.g., 610, 612, and/or 614) to include the first scale (e.g., 618, 622 and/or 630). In some embodiments, display of the second scale is visually different from (e.g., has a different color, size, and/or shape) display of the first scale. In some embodiments, the second scale is different from the first scale. In some embodiments, the second scale is different from the second representation of the current value. In some embodiments, while the second scale is displayed, the second representation of the current value is overlaid on, on top of, and/or over the second scale. In some embodiments, the first scale is a different color than the first representation of the current value, and the second scale is a different color than the second representation of the current value. In some embodiments, the first representation of the current value is a line, tick mark, and/or a point corresponding to a value, and the first scale indicates the range of values to which the first setting can be set. In some embodiments, the second representation of the current value is a line, tick mark, and/or a point corresponding to a value, and the second scale indicates the range of values to which the second setting can be set. Updating the display of one scale (e.g., first scale or second scale) without updating display of the second user interface object to include a second scale (e.g., second scale or first scale) corresponding to the second setting based on the first input corresponding to selection of the first user interface object or second user interface object provides the user with additional control over the user interface by allowing the computer system to automatically display a particular scale at the direction of the user, thereby providing additional control options without cluttering the user interface with additional user interface objects.

In some embodiments, the one or more inputs devices includes a first rotatable input mechanism (e.g., 616) (e.g., a crown, a knob, a dial, and/or a physical slider). In some embodiments, the first input (e.g., 605a1 and/or 605a2) is an input (e.g., a pressing input, a touching input, a tapping input, a long-press input, and/or a rotational input) that is directed to (e.g., on and/or that touches) the first rotatable input mechanism (e.g., as described above at FIGS. 2A-2C). Updating the display of one scale (e.g., first scale or second scale) without updating display of the second user interface object to include a second scale (e.g., second scale or first scale) corresponding to the second setting based on the first input that is directed to the first rotatable input mechanism provides the user with additional control over the user interface by allowing the computer system to display a particular scale at the direction of the user using the first rotatable input mechanism, thereby providing additional control options without cluttering the user interface with additional user interface objects.

In some embodiments, the one or more input devices includes a first touch-sensitive display (e.g., 604) (e.g., separate from the display component or the same as the display component). In some embodiments, the first input (e.g., 605a1 and/or 605a2) is an input (e.g., a pressing input, a touching input, a tapping input, a long-press input, and/or a rotational input) that is directed to (e.g., on and/or that touches) the first touch-sensitive display. Updating the display of one scale (e.g., first scale or second scale) without updating display of the second user interface object to include a second scale (e.g., second scale or first scale) corresponding to the second setting based on the first input that is directed to the first touch-sensitive display provides the user with additional control over the user interface by allowing the computer system to automatically display a particular scale at the direction of the user using the first touch-sensitive display, thereby providing additional control options without cluttering the user interface with additional user interface objects.

In some embodiments, the one or more inputs devices includes a second rotatable input mechanism (e.g., 616) (e.g., a crown, a knob, a dial, and/or a physical slider). In some embodiments, display of the plurality of user interface objects (e.g., 610, 612, and/or 614) at least partially (or, In some embodiments, completely) circumscribes the second rotatable input mechanism (e.g., as described above at FIG. 2A). In some embodiments, the display of the plurality of user interface objects forms (and/or is in) a circle or semi-circle. Updating the display of one scale (e.g., first scale or second scale) without updating display of the second user interface object to include a second scale (e.g., second scale or first scale) corresponding to the second setting based on the first input, where the scale is displayed around the second rotatable input mechanism, provides the user with additional control over the user interface by allowing the computer system to automatically display a particular scale at the direction of the user, thereby providing additional control options without cluttering the user interface with additional user interface objects and providing improved visual feedback to the user.

In some embodiments, while displaying, via the display component (e.g., 604), the first user interface object (e.g., 610, 612, and/or 614) that includes the first scale (e.g., 618, 622 and/or 630), the computer system detects, via the one or more input devices, a second input (e.g., 605a1 and/or 605a2). In some embodiments, in response to detecting the second input (e.g., while displaying, via the display component, the first user interface object that includes the first scale) (e.g., an input (e.g., a tap input and/or a rotational input) on a rotatable input mechanism and/or a tap on a control and/or user interface object) (and, In some embodiments, a non-tap input, such as a mouse click, gaze input, voice command, air gesture (e.g., a tap air gesture, a pinch gesture, and/or a flicking air gesture)) and in accordance with a determination that the second input corresponds to selection of the first user interface object, the computer system displays, via the display component (e.g., 605), a third scale (e.g., 620, 628, and/or 636) corresponding to the first setting (e.g., without updating the second user interface object to include the second scale), wherein the third scale includes (and/or is) an enlarged representation of the first scale. In some embodiments, in response to detecting the second input (e.g., while displaying, via the display component, the first user interface object that includes the first scale) and in accordance with a determination that the second input corresponds to selection of the first user interface object, the computer system ceases to display the plurality of user interface objects, the first representation, and/or the second representation. In some embodiments, in response to detecting the second input (e.g., while displaying, via the display component, the first user interface object that includes the first scale) and in accordance with a determination that the second input corresponds to selection of the first user interface object, the computer system ceases to display the first user interface object. In some embodiments, in response to detecting the second input (e.g., while displaying, via the display component, the first user interface object that includes the first scale) and in accordance with a determination that the second input corresponds to selection of the first user interface object, the computer system ceases to display the second user interface object. Displaying, via the display component, a third scale corresponding to the first setting in response to detecting the second input provides the user with additional control over the user interface by allowing the computer system to automatically display a particular scale at the direction of the user using the first touch-sensitive display, thereby providing additional control options without cluttering the user interface with additional user interface objects and providing improved visual feedback to the user.

In some embodiments, the one or more input devices includes a second touch-sensitive display (e.g., 604) (e.g., separate from the display component or the same as the display component). In some embodiments, the second input (e.g., 605a1 and/or 605a2) is an input (e.g., a pressing input, a touching input, a tapping input, a long-press input, and/or a rotational input) that is directed to (e.g., on and/or that touches) second touch-sensitive display. Displaying, via the display component, a third scale corresponding to the first setting in response to detecting the second input directed to the second touch-sensitive display provides the user with additional control over the user interface by allowing the computer system to automatically display a particular scale at the direction of the user using the second touch-sensitive display, thereby providing additional control options without cluttering the user interface with additional user interface objects and providing improved visual feedback to the user.

In some embodiments, the one or more inputs devices includes a third rotatable input mechanism (e.g., a crown, a knob, a dial, and/or a physical slider). In some embodiments, the second input (e.g., 605a1 and/or 605a2) is an input (e.g., a pressing input, a touching input, a tapping input, a long-press input, and/or a rotational input) that is directed to (e.g., on and/or that touches) the third rotatable input mechanism (e.g., 616). Displaying, via the display component, a third scale corresponding to the first setting in response to detecting the second input directed to the third rotatable input mechanism provides the user with additional control over the user interface by allowing the computer system to automatically display a particular scale at the direction of the user using the third rotatable input mechanism, thereby providing additional control options without cluttering the user interface with additional user interface objects and providing improved visual feedback to the user.

In some embodiments, in response to detecting the second input (e.g., 605a1 and/or 605a2) (e.g., while displaying, via the display component, the first user interface object that includes the first scale) and in accordance with a determination that the second input corresponds to selection of the second user interface object (e.g., 610, 612, and/or 614), the computer system updates display of the second user interface object to include the second scale (e.g., 618, 622 and/or 630) corresponding to the second setting. In some embodiments, in response to detecting the second input (e.g., while displaying, via the display component, the first user interface object that includes the first scale) and in accordance with a determination that the second input corresponds to selection of the second user interface object, the computer system ceases to display the first user interface object that includes the first scale. In some embodiments, in response to detecting the second input, the computer system continues to display the plurality of user interface objects, the first representation, and/or the second representation. Updating display of the second user interface object to include the second scale corresponding to the second setting in response to detecting the second input and in accordance with a determination that the second input corresponds to selection of the second user interface object provides the user with additional control over the user interface by allowing the computer system to display a particular scale at the direction of the user, thereby providing additional control options without cluttering the user interface with additional user interface objects and providing improved visual feedback to the user.

In some embodiments, the one or more inputs devices includes a fourth rotatable input mechanism (e.g., 616) (e.g., a crown, a knob, a dial, and/or a physical slider) (e.g., same as and/or different from the third rotatable input mechanism). In some embodiments, while displaying, via the display component (e.g., 604), the second user interface object (e.g., 610, 612, and/or 614) that includes the second scale (e.g., 618, 622 and/or 630), the computer system detects, via the one or more input devices, a third input (e.g., 605a1 and/or 605a2). In some embodiments, in response to detecting the third input (e.g., while displaying, via the display component, the second user interface object that includes the second scale) (e.g., an input (e.g., a tap input and/or a rotational input) on a rotatable input mechanism and/or a tap on a control and/or user interface object) (and, In some embodiments, a non-tap input, such as a mouse click, gaze input, voice command, air gesture (e.g., a tap air gesture, a pinch gesture, and/or a flicking air gesture)) and in accordance with a determination that the third input corresponds to selection of the second user interface object, the computer system displays, via the display component, a fourth scale (e.g., 620, 628, and/or 636) corresponding to the second setting, wherein: the fourth scale includes (and/or is) an enlarged representation of the second scale (e.g., without display the third scale; while (and/or after) the fourth scale is displayed, display of the fourth scale surrounds the fourth rotatable input mechanism by a first amount (e.g., as described above at FIG. 2C); and while (and/or after) the third scale (e.g., 620, 628, and/or 636) is displayed, display of the third scale surrounds the fourth rotatable input mechanism by a second amount that is different from the first amount (e.g., as described above at FIG. 2C). Displaying scales that go around the rotatable input mechanism by different amounts in response to detecting inputs provides the user with additional control over the user interface by allowing the computer system to display a particular scale at the direction of the user and provides feedback to the user concerning the values in which the scale can be set, thereby providing additional control options without cluttering the user interface with additional user interface objects and providing improved visual feedback to the user.

In some embodiments, in response to detecting the second input (e.g., 605a1 and/or 605a2) and in accordance with a determination that the second input corresponds to selection of the first user interface object (610, 612, and/or 614), the computer system displays, via the display component (e.g., 604), an indication on the third scale (e.g., 620, 628, and/or 636) at a location corresponding to a current value of the first setting (and/or, In some embodiments, an enlarged representation of the first representation on the third scale) (and, In some embodiments, cease to display the first representation and/or the second representation). Displaying, via the display component, an indication on the third scale at a location corresponding to a current value of the first setting in response to detecting the second input and in accordance with a determination that the second input corresponds to selection of the first user interface object provides the user with additional control over the user interface by allowing the computer system to display a particular scale at the direction of the user with a current value of the scale and provides feedback to the user concerning the values in which the scale can be set, thereby providing additional control options without cluttering the user interface with additional user interface objects and providing improved visual feedback to the user.

In some embodiments, in response to detecting the third input (e.g., 605a1 and/or 605a2) and in accordance with a determination that the third input corresponds to selection of the second user interface object (e.g., 610, 612, and/or 614), the computer system displays, via the display component (e.g., 604), an indication on the fourth scale (e.g., 620, 628, and/or 636) at a location corresponding to a current value of the second setting (and/or, In some embodiments, an enlarged representation of the second representation on the fourth scale) (and, In some embodiments, cease to display the first representation and/or the second representation), wherein display of the indication on the fourth scale is visually different from (e.g., has a different position on the display and/or different in color, shape, and/or size) display of the indication on the third scale (e.g., 620, 628, and/or 636). Displaying, via the display component, an indication on the fourth scale at a location in response to detecting the third input and in accordance with a determination that the third input corresponds to selection of the second user interface object provides the user with additional control over the user interface by allowing the computer system to display a particular scale at the direction of the user with a different indication and provides feedback to the user concerning the difference between scales, thereby providing additional control options without cluttering the user interface with additional user interface objects and providing improved visual feedback to the user.

In some embodiments, while displaying, via the display component (e.g., 604), the third scale (e.g., 620, 628, and/or 636) or the fourth scale (e.g., 620, 628, and/or 636), the computer system detects a rotation of a fifth rotatable input mechanism (e.g., 616) (e.g., a rotatable input mechanism) (e.g., a crown, a knob, a dial, and/or a physical slider) (e.g., same as and/or different from the third rotatable input mechanism). In some embodiments, in response to detecting the rotation of the fifth rotatable input mechanism and in accordance with a determination that the third scale was displayed while the rotation of the physical input mechanism was detected, the computer system generates a first set of one or more haptics. In some embodiments, in response to detecting the rotation of the fifth rotatable input mechanism and in accordance with a determination that the fourth scale was displayed while the rotation of the physical input mechanism was detected, the computer system generates a second set of one or more haptics that is different from (e.g., different in number, different in spacing between the haptics, different in length of haptics and/or individual haptics that are generated) the first set of one or more haptics (e.g., as described above at FIG. 2B). Generating different sets of haptics based on which scale was displayed while the rotation of the physical input mechanism in response to detecting rotation of the fifth rotatable input mechanism allows the computer system to automatically output feedback concerning the received input, thereby providing additional control options without cluttering the user interface with additional user interface objects, performing an operation when a set of conditions has been met without requiring further user input, and providing improved visual feedback to the user.

In some embodiments, in response to detecting the first input (e.g., 605a1 and/or 605a2), the computer system generates a third set of one or haptics that is different from the first set of one or more haptics and the second set of one or more haptics (e.g., as described above at FIG. 2A). Generating a third set of one or haptics that is different from the first set of one or more haptics and the second set of one or more haptics in response to detecting the first input allows the computer system to automatically output feedback concerning the received input, thereby providing additional control options without cluttering the user interface with additional user interface objects, performing an operation when a set of conditions has been met without requiring further user input, and providing improved visual feedback to the user.

In some embodiments, in response to detecting the second input (e.g., 605a1 and/or 605a2) and in accordance with a determination that the second input corresponds to selection of the first user interface object (610, 612, and/or 614), the computer system displays, via the display component (e.g., 604), a numerical representation (e.g., 620, 628, and/or 636) (e.g., a numerical character and/or one or more numbers) of the current value for the first setting concurrently with the third scale (e.g., 620, 628, and/or 636), wherein the numerical representation of the current value for the first setting was not previously displayed before the second input was detected. Displaying a numerical representation of the current value for the first setting concurrently with the third scale in response to detecting the second input and in accordance with a determination that the second input corresponds to selection of the first user interface object in response to detecting the second input allows the computer system to automatically display numerical representations of the current value for the first setting, thereby providing additional control options without cluttering the user interface with additional user interface objects, performing an operation when a set of conditions has been met without requiring further user input, and providing improved visual feedback to the user.

In some embodiments, while displaying, via the display component (e.g., 604), the third scale (e.g., 620, 628, and/or 636), the computer system detects an input (e.g., 605d) corresponding to a movement input (e.g., a swipe input, an air gesture, a gaze input, a click-and-drag input, and/or a dragging input). In some embodiments, in response to detecting the input corresponding to the movement input, the computer system updates the current value for the first setting to a new value based on movement of the input corresponding to the movement input (e.g., as described above at FIG. 2E). In some embodiments, in response to detecting the input corresponding to the movement input, the computer system causes output of a device (e.g., a fan, a thermostat, a window, a door, an actuator, a speaker, and/or a chair) corresponding to the first setting to change (e.g., as described above at FIG. 2E) (e.g., without causing output of a device corresponding to the second setting to change) (e.g., a device that is in communication with the computer system) (e.g., based on the new value and/or a different value). Updating the current value for the first setting to a new value based on movement of the input corresponding to the movement input and causing output of a device corresponding to the first setting to change in response to detecting the input corresponding to the movement input provides a user with more control over the computer system to cause the output of a device to change, thereby providing additional control options without cluttering the user interface with additional user interface objects.

In some embodiments, the computer system (e.g., 600) is in communication with a sixth rotatable input mechanism (e.g., 616) (e.g., a crown, a knob, a dial, and/or a physical slider) (e.g., same as and/or different from the fourth rotatable input mechanism). In some embodiments, the input corresponding to the movement input (e.g., 605d) is a rotation of the sixth rotatable input mechanism (e.g., 616). Updating the display of one scale (e.g., first scale or second scale) without updating display of the second user interface object to include a second scale (e.g., second scale or first scale) corresponding to the second setting based on the first input that includes a rotation of a rotatable input mechanism provides the user with additional control over the user interface by allowing the computer system to automatically display a particular scale at the direction of the user using the rotatable input mechanism, thereby providing additional control options without cluttering the user interface with additional user interface objects.

In some embodiments, the sixth rotatable input mechanism (e.g., 616) includes a respective display (e.g., 604). In some embodiments, the respective display includes a user interface that is updated as the current value for the first setting is updated (e.g., as described above at FIG. 2E). In some embodiments, the display is the display component. In some embodiments, the user interface includes a scale corresponding to the first setting (and/or a scale corresponding to another setting) and/or the first scale, second scale, third scale, and/or fourth scale. Updating the display of one scale (e.g., first scale or second scale) without updating display of the second user interface object to include a second scale (e.g., second scale or first scale) corresponding to the second setting based on the first input that includes a rotation of a rotatable input mechanism that includes display provides the user with additional control over the user interface by allowing the computer system to automatically display a particular scale at the direction of the user using the rotatable input mechanism that includes the display, thereby providing additional control options without cluttering the user interface with additional user interface objects and providing the user with improved feedback.

In some embodiments, after displaying, via the display component (e.g., 604), the third scale (e.g., 620, 628, and/or 636) corresponding to the first setting and in accordance with a determination that an input (e.g., 605a1, 605c, and/or 605d) has not been detected for a predetermined period of time (e.g., after the second input was detected and/or after another input was detected), the computer system displays (e.g., re-displays and/or displays again) the plurality of controls (e.g., 610, 612, and/or 614) (e.g., as described above at FIG. 2E) (e.g., and/or re-displaying the first scale and/or a scale corresponding to the enlarged scale that was displayed before the determination occurred). In some embodiments, in accordance with a determination that an input has been detected for the predetermined period of time, the computer system continues to display the third scale. In some embodiments, in accordance with a determination that the input has been detected for the predetermined period of time, the computer system forgoes re-displaying the plurality of controls and continuing to display the third scale. Displaying the plurality of controls in accordance with a determination that an input has not been detected for a predetermined period of time allows the computer system to automatically provide the plurality of controls when a set of conditions are met, thereby performing an operation when a set of conditions has been met without requiring further user input.

In some embodiments, the computer system (e.g., 600) is in communication with a seventh rotatable input mechanism (e.g., 616) (e.g., a crown, a knob, a dial, and/or a physical slider) (e.g., same as and/or different from the input rotatable input mechanism). In some embodiments, in response to detecting an input (e.g., 605a1, 605c, and/or 605d) directed to the seventh rotatable input mechanism, the computer system displays (e.g., re-displays and/or displays again) the plurality of controls (e.g., 610, 612, and/or 614) (e.g., and/or re-displaying the first scale and/or a scale corresponding to the enlarged scale that was displayed before the determination occurred). Displaying the plurality of controls in response to detecting an input directed to the seventh rotatable input mechanism allows the computer system to automatically provide the plurality of controls when a set of conditions are met, thereby performing an operation when a set of conditions has been met without requiring further user input.

In some embodiments, displaying the plurality of controls (e.g., 610, 612, and/or 614) in response to detecting an input (e.g., 605a1, 605c, and/or 605d) directed to the seventh rotatable input mechanism (e.g., 616) includes displaying (e.g., re-displaying and/or displaying again) the first user interface object (610, 612, and/or 614) that includes the first scale (e.g., 618, 622 and/or 630) and the second user interface object (e.g., 610, 612, and/or 614) without displaying the second scale (e.g., 618, 622 and/or 630). In some embodiments, displaying the plurality of controls in response to detecting an input directed to the seventh rotatable input mechanism includes re-displaying the first representation of the current value for the first setting. In some embodiments, the position of the first representation of the current value for the first setting is changed if the current value of the first setting was reset in response to detecting a rotation of the rotatable input mechanism while the third scale (e.g., the enlarged scale for the first setting) was displayed.

In some embodiments, display of the second scale (e.g., 618, 622 and/or 630) is visually different from display of the first scale (e.g., 618, 622 and/or 630). In some embodiments, one scale is a multi-colored (e.g., red, blue, yellow, and orange) gradient while other scale is single color gradient. In some embodiments, one scale is multi-colored while the other scale is a solid color. Updating the display of one scale (e.g., first scale or second scale) without updating display of the second user interface object to include a second scale (e.g., second scale or first scale) corresponding to the second setting based on the first input corresponding to selection of the first user interface object or second user interface object, where the scales are visually different, provides the user with additional control over the user interface by allowing the computer system to automatically display a particular scale at the direction of the user, thereby providing additional control options without cluttering the user interface with additional user interface objects.

Note that details of the processes described above with respect to process 700 (e.g., FIGS. 3A-3B) are also applicable in an analogous manner to other methods described herein. For example, process 1100 optionally includes one or more characteristics of the various methods described above with reference to process 700. For example, a scale can be displayed using the techniques described above in relation to process 700, where the appearance of the scale is adjusted using one or more techniques described below in relation to process 1100.

FIGS. 4A-4F illustrate exemplary user interfaces for controlling the display of controls in accordance with some embodiments. The user interfaces in these figures are used to illustrate the processes described below, including the processes in FIGS. 5A-5B.

At FIG. 4A, computer system 600 is operating in a sleep mode. Computer system 600 does not display a respective user interface and/or respective user interface objects on display 604 while computer system 600 is in the sleep mode. FIG. 4A illustrates portion of body 810. Portion of body 810 is one or more body parts (e.g., one or more digits (e.g., finger and/or toes), limb (e.g., arm and/or leg), torso, and/or head) of a user of computer system 600. As illustrated in FIG. 4A, portion of body 810 is near computer system 600. That is, at FIG. 4A, portion of body 810 is within predetermined distance threshold 818 of rotatable input mechanism 616.

At FIG. 4A, computer system 600 detects that portion of body 810 is within predetermined distance threshold 818 of rotatable input mechanism 616 for an amount of time that is greater than a predetermined time threshold (e.g., 0.5, 1, 3, 5, 7, or 10 seconds). In some embodiments, computer system 600 detects that portion of body 810 is within predetermined distance threshold 818 of rotatable input mechanism 616 via a wireless signal (e.g., NFC, Bluetooth, and/or Wi-Fi). In some embodiments, computer system 600 is in communication (e.g., wireless and/or wired communication) with one or more cameras. In embodiments where computer system 600 is in communication with the one or more cameras, computer system 600 detects that portion of body 810 is within predetermined distance threshold 818 for the predetermined amount of time via the one or more cameras. In some embodiments, computer system 600 does not detect that portion of body 810 contacts computer system 600 as a part of computer system 600 determining that portion of body 810 is within predetermined distance threshold 818 of rotatable input mechanism 616. In some embodiments, computer system 600 displays a respective user interface and/or user interface objects while computer system 600 detects that portion of body 810 is within predetermined distance threshold 818 of rotatable input mechanism 616.

In each of FIGS. 4B-4D, computer system 600 continues to detect that portion of body 810 is within predetermined distance threshold 818 of rotatable input mechanism 616 (e.g., portion of body 810 remains in near rotatable input mechanism 616 in FIGS. 4B-4D).

As illustrated in FIG. 4B, in response to computer system 600 detecting that portion of body 810 is within predetermined distance threshold 818 of rotatable input mechanism 616 for the predetermined time threshold, computer system 600 displays fan control user interface object 806, temperature control user interface object 808, volume control user interface object 814, and light control user interface object 812. As illustrated in FIG. 4B, computer system 600 displays each of fan control user interface object 806, temperature control user interface object 808, volume control user interface object 814, and light control user interface object 816 near rotatable input mechanism 616 (e.g., computer system 600 displays each of fan control user interface object 806, temperature control user interface object 808, volume control user interface object 814, and light control user interface object 816 on a portion of display 604 closer to rotatable input mechanism 616 than a different portion of display 604). In some embodiments, computer system 600 displays each of fan control user interface object 806, temperature control user interface object 808, volume control user interface object 814, and light control user interface object 816 above, to the side, or below rotatable input mechanism 616. In some embodiments, computer system 600 displays a respective control user interface object on each side of rotatable input mechanism 616.

In some embodiments, computer system 600 maintains the display of each of fan control user interface object 806, temperature control user interface object 808, volume control user interface object 814, and light control user interface object 816 while two conditions are satisfied. In some embodiments, the first condition is that computer system 600 does not detect that portion of body 810 is outside predetermined distance threshold 818 of rotatable input mechanism 616 for a threshold amount of time (e.g., 1, 3, 5, 7, 10, 15, 25 seconds). In some embodiments, the second condition is that a first time threshold (e.g., 1, 3, 5, 10, 13, 15 or 20 seconds) has not elapsed since computer system 600 last detected an input (e.g., a tap input, a swipe input, or an input that corresponds to a rotation of rotatable input mechanism 616 was rotated). In some embodiments, computer system 600 will cease to display each of fan control user interface object 806, temperature control user interface object 808, volume control user interface object 814, and light control user interface object 812 while computer system 600 detects that portion of body 810 is within predetermined distance threshold 818 of rotatable input mechanism 616 if the first time threshold has elapsed since computer system 600 last detected an input.

Fan control user interface object 806 corresponds to a fan device, temperature control user interface object 808 corresponds to an air conditioning device (e.g., a device capable of heating and/or cooling a space), volume control user interface object 814 corresponds to one or more speaker devices, and light control user interface object 816 corresponds to one or more light devices. As explained in greater detail below, each of fan control user interface object 806, temperature control user interface object 808, volume control user interface object 814, and light control user interface object 812 can be selected to configure computer system 600 to control the operation of the device that corresponds to the selected control user interface object. In some embodiments, one or more of the fan device, air conditioning device, one or more speaker devices, and/or one or more light devices are integrated into computer system 600. In some examples one or more of the fan device, air conditioning device, one or more speaker devices, and/or one or more light devices are not integrated into computer system 600. In some examples one or more of the fan device, air conditioning device, one or more speaker devices, one or more light devices and/or computer system 600 are coupled to a common external structure (e.g., a home, an airplane, a bus, a car, and/or boat). In some embodiments, computer system 600 displays fan control user interface object 806, temperature control user interface object 808, volume control user interface object 814, and light control user interface object 816 in a configuration that corresponds to the rotation of rotatable input mechanism 616 (e.g., computer system 600 displays fan control user interface object 806, temperature control user interface object 808, volume control user interface object 814, and light control user interface object 812 in a half circle configuration if rotatable input mechanism 616 rotates about an z-axis or computer system 600 displays fan control user interface object 806, temperature control user interface object 808, volume control user interface object 814, and light control user interface object 812 in a circle that extends into/out of display 604 if rotatable input mechanism 616 rotates about a x-axis). In some embodiments, computer system 600 resizes/moves the display of a respective user interface and/or user interface objects as a part of displaying fan control user interface object 806, temperature control user interface object 808, volume control user interface object 814, and light control user interface object 812 such that computer system 600 does not display fan control user interface object 806, temperature control user interface object 808, volume control user interface object 814, and light control user interface object 812 as overlaid on the respective user interface and/or user interface objects. In some embodiments, computer system 600 does not display fan control user interface object 806, temperature control user interface object 808, volume control user interface object 814, and light control user interface object 816 as overlaid on top of user interface elements that computer system 600 displays prior to computer system 600 detecting that portion of body 810 is within predetermined distance threshold 818 of rotatable input mechanism 616. In some embodiments, computer system 600 displays fan control user interface object 806, temperature control user interface object 808, volume control user interface object 814, and light control user interface object 812 in response to computer system 600 detecting that portion of body 810 is within the predetermined distance of a hardware component (e.g., display 604, a hardware button, and/or backside of computer system 600) of computer system 600 that is not rotatable input mechanism 616.

As illustrated in FIG. 4B, computer system 600 displays fan control user interface object 806 as visually emphasized (e.g., computer system 600 displays fan control user interface object 806 with hatching and/or color to indicate that fan control user interface object 806 is visually emphasized). At FIG. 4B, computer system 600 detects input 805b that corresponds to a rotation of rotatable input mechanism 616. In some embodiments, in order to visually emphasize fan control user interface object 806, computer system 600 displays fan control user interface object 806 as a different color than temperature control user interface object 808, volume control user interface object 814, and light control user interface object 816. In some embodiments, input 805b corresponds to a tap input, swipe input, voice command, a gaze, and/or a hand gesture.

At FIG. 4C, in response to detecting input 805b, computer system 600 scrolls from fan control user interface object 806 to volume control user interface object 814. At FIG. 4C, as a part of scrolling from fan control user interface object 806 to volume control user interface object 814, computer system 600 ceases to display fan control user interface object 806 as visually emphasized and computer system 600 displays volume control user interface object 814 as visually emphasized. In some embodiments, computer system 600 displays fan control user interface object 806, temperature control user interface object 808, volume control user interface object 814, and light control user interface object 816 as rotating about and x-axis in and out of display 604 in a circle as a part of computer system 600 scrolling fan control user interface object 806, temperature control user interface object 808, volume control user interface object 814, and light control user interface object 812. In some embodiments, the direction at which computer system 600 scrolls fan control user interface object 806, temperature control user interface object 808, volume control user interface object 814, and light control user interface object 812 is based on the detected rotation direction of rotatable input mechanism 616 (e.g., computer system 600 scrolls fan control user interface object 806, temperature control user interface object 808, volume control user interface object 814, and light control user interface object 812 in a first direction in response to computer system 600 detecting that rotatable input mechanism 616 is rotated in a clockwise direction and computer system 600 scrolls fan control user interface object 806, temperature control user interface object 808, volume control user interface object 814, and light control user interface object 812 in a second direction (e.g., opposite the first direction) in response to computer system 600 detecting that rotatable input mechanism 616 is rotated in a counterclockwise direction). In some embodiments, the speed at which computer system 600 scrolls fan control user interface object 806, temperature control user interface object 808, volume control user interface object 814, and light control user interface object 812 corresponds the detected rotation speed of rotatable input mechanism 616 (e.g., the rate at which computer system 600 scrolls fan control user interface object 806, temperature control user interface object 808, volume control user interface object 814, and light control user interface object 812 is directly to the speed at which computer system 600 detects rotatable input mechanism 616 as being rotated). In some embodiments, in response to detecting input 805b and while computer system displays fan control user interface object as visually emphasized (e.g., the fan device is the targeted device), computer system 600 transmits instructions to the fan device that modify the operation of the fan device without changing the operation of the air conditioning device, the one or more speaker devices, or the one or more light devices. In some embodiments, in response to detecting input 805b and while computer system displays fan control user interface object as visually emphasized (e.g., the fan device is the targeted device), computer system 600 does not transmit instructions to the fan device that modify the operation of the fan device.

At FIG. 4C, while computer system 600 displays volume control user interface object 814 as visually emphasized, computer system 600 detects input 805c that corresponds to a depression of rotatable input mechanism 616. In some embodiments, input 805c corresponds to a tap input, swipe input, a gaze, a hand gesture, voice command, and/or a rotation of rotatable input mechanism 616. In some embodiments, computer system 600 continues to display fan control user interface object 806, temperature control user interface object 808, volume control user interface object 814, and light control user interface object 816 while computer system 600 detects that rotatable input mechanism 616 is being rotated. In some embodiments, while computer system 600 displays fan control user interface object 806, temperature control user interface object 808, volume control user interface object 814 and light control user interface object 816, computer system 600 does not transmit instructions to the fan device, the air conditioning device, the one or more speaker devices, or the one or more light devices in response to detecting an input. In some embodiments, computer system 600 updates the display of a respective user interface object and does not update the display of fan control user interface object 806, temperature control user interface object 808, volume control user interface object 814, and light control user interface object 812 in response to detecting an input.

As illustrated in FIG. 4D, in response to detecting input 805c while computer system 600 displays volume control user interface object 814 as visually emphasized, computer system 600 displays volume scale user interface object 822 and ceases to display fan control user interface object 806, temperature control user interface object 808, volume control user interface object 814, and light control user interface object 812. Volume scale user interface object 822 includes volume representation user interface object 830. The length of volume scale user interface object 822 corresponds to the range of the volume settings of the one or more speaker devices (e.g., that correspond to volume control user interface object 814). The leftmost portion of volume scale user interface object 822 corresponds to the minimum volume setting of the one or more speaker devices and the rightmost portion of volume scale user interface object 822 represents the maximum volume setting of the one or more speaker devices. Volume representation user interface object 830 represents the current volume level of the one or more speaker devices. In some embodiments, computer system 600 displays volume scale user interface object at the same position on display 604 that computer system 600 displays volume control user interface object 814.

Computer system 600 ceases to display fan control user interface object 806, temperature control user interface object 808, volume control user interface object 814, and light control user interface object 816 as a part of displaying volume scale user interface object 822. In some embodiments, volume scale user interface object 822 includes a numerical representation of the current volume setting of the one or more speaker devices. In some embodiments, computer system 600 continues to display volume control user interface object 814 and ceases to display each of fan control user interface object 806, temperature control user interface object 808, and light control user interface object 816 as a part of displaying volume scale user interface object 822. In some embodiments, computer system 600 displays fan control user interface object 806, temperature control user interface object 808, volume control user interface object 814, and light control user interface object 816 while computer system 600 displays volume scale user interface object 822.

As explained in greater detail below, computer system 600 is configured to control the volume setting of the one or more speaker devices while computer system 600 displays volume scale user interface object. At FIG. 4D, computer system 600 detects input 805d that corresponds to a rotation of rotatable input mechanism 616. In some embodiments, input 805d corresponds to a tap input, swipe input, a gaze, voice command, depression of rotatable input mechanism 616 and/or a hand gesture. In some embodiments, input 805d corresponds to a swipe input on the display of volume representation user interface object 830.

At FIG. 4E, in response to computer system 600 detecting input 805d, computer system 600 transmits instructions to the one or more speaker devices that cause the volume setting of the one or more speaker devices to increase (e.g., in comparison to the volume setting of the one or more speaker devices at FIG. 4D). Computer system 600 moves the display of volume indicator 820 to the right on volume scale user interface object 822 to represent the new volume setting of the one or more speaker devices. In some embodiments, the volume setting is adjusted based on the detected direction of the rotation of rotatable input mechanism 616 (e.g., the volume setting is increased if computer system 600 detects that rotatable input mechanism 616 is rotated in a clockwise direction and the volume setting is decreased if computer system 600 detects that rotatable input mechanism 616 is rotated in the counterclockwise direction). In some embodiments, the magnitude of the change of the volume setting is based on the on the detected speed of the rotation of rotatable input mechanism 616.

At FIG. 4E, computer system 600 detects that portion of body 810 is positioned at a distance from rotatable input mechanism 616 that is outside of predetermined distance threshold 818 for a second time threshold.

At FIG. 4F, in response to computer system 600 detecting that portion of body 810 is positioned at a distance from rotatable input mechanism 616 that is greater than predetermined distance threshold 818 for a second time threshold, computer system 600 ceases to display volume scale user interface object 822. The second time threshold is less than the first time threshold (e.g., as discussed above in reference to FIG. 4B). That is, the amount of time computer system 600 is required to detect that portion of body 810 is positioned at a distance that is greater than predetermined distance threshold 818 in order for computer system 600 to cease the display of volume scale user interface object 822 is less that the amount of time computer system 600 is required to go without detecting an input while portion of body 810 is positioned within predetermined distance threshold 818 in order for computer system 600 to cease the display of volume scale user interface object 822. For example, computer system 600 ceases to display volume scale user interface object 822 after 3 seconds have elapsed since computer system 600 detects that portion of body 810 is positioned at a distance that is greater than predetermined distance threshold 818. In contrast, while portion of body 810 is positioned at a distance from rotatable input mechanism 616 that is within the predetermined distance threshold 818, computer system 600 ceases to display volume scale user interface object 822 after computer system 600 has not detected an input for 10 seconds. In some embodiments, computer system 600 displays one or more of fan control user interface object 806, temperature control user interface object 808, volume control user interface object 814, and light control user interface object 816 as a part of ceasing to display volume scale user interface object 822. In some embodiments, computer system 600 redisplays volume scale user interface object 822 in response to detecting that portion of body 810 is within predetermined distance threshold 818 for the first time threshold. In some embodiments, computer system 600 displays fan value user interface object 610, temperature value user interface object 612, and/or volume value user interface object 614 in response to detecting that portion of body 810 is within predetermined distance threshold 818 of rotatable input mechanism 616 for an amount of time that is greater than a predetermined time threshold.

FIGS. 5A-5B is a flow diagram illustrating a method (e.g., process 900) for displaying controls in accordance with some embodiments. Some operations in process 900 are, optionally, combined, the orders of some operations are, optionally, changed, and some operations are, optionally, omitted.

As described below, process 900 provides an intuitive way for displaying. Process 900 reduces the cognitive burden on a user for displaying controls, thereby creating a more efficient human-machine interface. For battery-operated computing devices, enabling a user to display controls faster and more efficiently conserves power and increases the time between battery charges.

In some embodiments, process 900 is performed at a computer system (e.g., 600) that is in communication with a display component (e.g., 604) (e.g., a display screen and/or a touch-sensitive display), one or more input devices (e.g., a camera, a touch-sensitive display, a microphone, and/or a button), and a physical input mechanism (e.g., 616) (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

While displaying a respective user interface, the computer system detects (902), via the one or more inputs devices, an intent to control the physical input mechanism (e.g., 616) (e.g., as described above at FIG. 2A) (e.g., a body part (e.g., a hand), a pointer, and/or gaze that is within a predetermined distance away from and/or moving toward (e.g., within a predetermined amount of time) the physical input mechanism and/or an air gesture and/or gaze that is directed to the physical input mechanism).

In response to detecting the intent to control the physical input mechanism (e.g., 616), the computer system displays (904), via the display component (e.g., 604), one or more user interface objects (e.g., 806, 808, 814, and/or 816) on the respective user interface, wherein movement of the physical input mechanism causes the computer system (e.g., 600) to update display at least one of the one or more user interface objects. In some embodiments, in response to detecting movement of the physical input mechanism, the computer system causes a setting (e.g., as described above in relation to process 700) for a device (e.g., a speaker, a thermostat, a door (e.g., front door and/or back door), a fan, a light, and/or a window component (e.g., blinds, a window opening, and/or a window tint)) to be adjusted and/or causes the device to adjust output.

While displaying the one or more respective user interface objects on the respective user interface and in accordance with a determination that the physical input mechanism (e.g., 616) is not moving, the intent to control the physical input mechanism continues to be detected, and a predetermined period of time has not passed (e.g., since the rotatable input mechanism was moved or since the hand was near the rotatable input mechanism) (e.g., as described above at FIG. 4B), the computer system continues (908) to display the one or more respective user interface objects (e.g., 806, 808, 814, and/or 816) on the respective user interface.

While displaying the one or more respective user interface objects on the respective user interface and in accordance with a determination that the physical input mechanism (e.g., 616) is not moving, the intent to control the physical input mechanism continues to be detected, and a predetermined period of time has passed (e.g., since the rotatable input mechanism was moved or since the hand was near the rotatable input mechanism), the computer system ceases (910) to display the one or more respective user interface objects on the respective user interface (e.g., as described above at FIG. 2B).

While displaying the one or more respective user interface objects on the respective user interface and ion accordance with a determination that the physical input mechanism (e.g., 616) is not moving and the intent to control the physical input mechanism does not continue to be detected (and, In some embodiments, irrespective of whether or not the predetermined period of time has passed (e.g., since the rotatable input mechanism was moved or since the hand was near the rotatable input mechanism)), the computer system ceases (912) to display the one or more respective user interface objects on the respective user interface (e.g., as described above at FIG. 6B). Continuing to display the one or more respective user interface objects on the respective user interface or ceasing to display the one or more respective user interface objects on the respective user interface when prescribed conditions are met allows the computer system to automatically cease to display or continue to display the one or more respective user interface objects based on certain conditions being met, thereby providing additional control options without cluttering the user interface with additional user interface objects and performing an operation when a set of conditions has been met without requiring further user input.

In some embodiments, detecting the intent to control the physical input mechanism includes detecting that a body part (e.g., hand, head, arm, finger, toe, and/or foot) of a user (e.g., 810) is within a predetermined distance (e.g., 0.1-50 centimeters) from an area that includes the physical input mechanism (e.g., as described above at FIG. 4A). Continuing to display the one or more respective user interface objects on the respective user interface or ceasing to display the one or more respective user interface objects on the respective user interface based on detecting that a body part of a user is within a predetermined distance from an area that includes the physical input mechanism provides the user with control over the computer system to choose whether the one or more respective user interface objects should be displayed, thereby providing additional control options without cluttering the user interface with additional user interface objects and performing an operation when a set of conditions has been met without requiring further user input.

In some embodiments, the area surrounds (e.g., and/or circumscribes) at least a portion of the physical input mechanism. In some embodiments, the shape of the area is a circle and/or semi-circle.

In some embodiments, in response to detecting the intent to control the physical input mechanism (e.g., as described above at FIG. 4A) and in accordance with a determination that the physical input mechanism (e.g., 616) is moving, the computer system continues to display the one or more respective user interface objects (e.g., 806, 808, 814, and/or 816) on the respective user interface. Continuing to display the one or more respective user interface objects on the respective user interface in response to detecting the intent to control the physical input mechanism and in accordance with a determination that the physical input mechanism is moving provides the user with control over the computer system to choose whether the one or more respective user interface objects is displayed, thereby providing additional control options without cluttering the user interface with additional user interface objects, performing an operation when a set of conditions has been met without requiring further user input, and provides improved feedback (e.g., sensory, visual, auditory, and touching).

In some embodiments, the one or more user interface objects (e.g., 806, 808, 814, and/or 816) includes: a first user interface object (e.g., 806, 808, 814, and/or 816) that has a first visual appearance (e.g., a size, shape, color, and/or including one or more graphical representations (e.g., different types of graphical representations)); and a second user interface object (e.g., 806, 808, 814, and/or 816) that has a second visual appearance (e.g., a size, shape, color, and/or including one or more graphical representations (e.g., different types of graphical representations)) that is different form the first visual appearance.

In some embodiments, while displaying the one or more user interface objects (e.g., 806, 808, 814, and/or 816) including the first user interface object (e.g., 806, 808, 814, and/or 816) and the second user interface object (e.g., 806, 808, 814, and/or 816), the computer system detects an input (e.g., 805b) (e.g., an input (e.g., a tap input and/or a rotational input) on a rotatable input mechanism and/or a tap on a control and/or user interface object) (and, In some embodiments, a non-tap input, such as a mouse click, gaze input, voice command, air gesture (e.g., a tap air gesture, a pinch gesture, and/or a flicking air gesture)), via the one or more input devices, directed to the one or more user interface objects. In some embodiments, in response to detecting the input directed to the one or more user interface objects and in accordance with a determination that the input directed to the one or more user interface objects is directed to the first user interface object, the computer system causes output of a first device to change (e.g., where the first device corresponds to the first user interface object) without causing output of a second device to change (e.g., where the second device corresponds to the first user interface object) (e.g., to increase and/or decrease), wherein the second device is different from the first device (e.g., as described above at FIG. 4C). In some embodiments, in response to detecting the input directed to the one or more user interface objects and in accordance with a determination that the input directed to the one or more user interface objects is directed to the second user interface object, the computer system causes output of the second device to change without causing output of the first device to change (e.g., as described above at FIG. 4C). Causing output of a first device to change without causing output of a second device to change or causing output of the second device to change without causing output of the first device to change in response to detecting the input directed to the one or more user interface objects provides the user with more control over the computer system to cause a device's output to change based on the user interface object in which the input was directed, thereby providing additional control options without cluttering the user interface with additional user interface objects, performing an operation when a set of conditions has been met without requiring further user input, and provides improved feedback (e.g., sensory, visual, auditory, and touching).

In some embodiments, the one or more user interface objects (e.g., 806, 808, 814, and/or 816) are displayed in a portion of the respective user interface that is closer to a location of the physical input mechanism (e.g., 616) (e.g., in the portion of the user interface that is the closet to the physical input mechanism than the other portions of the respective user interface) (e.g., within an average adult's thumb distance away from) than another portion of the respective user interface (e.g., as described above at FIG. 4B). Displaying the one or more user interface objects a portion of the respective user interface that is closer to a location of the physical input mechanism than another portion of the respective user interface provides a user with feedback that the one or more user interface objects can be controlled and/or manipulated via input that is directed to the physical input mechanism, thereby providing improved feedback and providing additional control options without cluttering the user interface with additional user interface objects.

In some embodiments, the one or more user interface objects (e.g., 806, 808, 814, and/or 816) are displayed in an arrangement (e.g., a shape and/or a layout) that indicates a direction that the rotatable input mechanism (e.g., 616) can be moved (e.g., as described above at FIG. 4A) (e.g., a semi-color that starts at one position and that ends at another position on the user interface). In some embodiments, the rotatable input mechanism rotates in a first direction and the one or more user interface objects (when the one or more user interface objects includes a plurality of user interface objects) are aligned in the first direction. Displaying the one or more user interface objects are displayed in an arrangement that indicates a direction that the rotatable input mechanism can be moved provides a user with feedback that the one or more user interface objects can be controlled and/or manipulated via input that is directed to the physical input mechanism, thereby providing improved feedback and providing additional control options without cluttering the user interface with additional user interface objects.

In some embodiments, before detecting, via the one or more inputs devices, the intent to control the physical input mechanism (e.g., as described above at FIG. 4A), the respective user interface includes visual information and does not include the one or more user interface objects (e.g., 806, 808, 814, and/or 816). In some embodiments, in response to detecting the intent to control the physical input mechanism, the one or more user interface objects are displayed concurrently with the visual information and are not overlaid on (e.g., not displayed on top of, not displayed over, does not obstruct display of) the visual information (e.g., as described above at FIG. 4B). Displaying the one or more user interface objects concurrently with the visual information, where the one or more user interface objects and are not overlaid on the visual information provides the user with controls options for performing one or more operations while also allow the user to view visual information, thereby providing additional control options without cluttering the user interface with additional user interface objects.

In some embodiments, while displaying the one or more user interface objects (e.g., 806, 808, 814, and/or 816), the computer system displays an indication that a third user interface object of the one or more user interface objects is selected (e.g., 806 at FIG. 4B and/or 814 at FIG. 4C). In some embodiments, while displaying the indication that the third user interface object is selected, the computer system detects a rotation (e.g., 805b and/or 805d) (e.g., counterclockwise and/or clockwise) of the physical input mechanism (e.g., 616). In some embodiments, in response to detecting the rotation of the physical input mechanism, the computer system displays an indication (e.g., a focus indicator, highlighting of a respective user interface object, bolding of a respective user interface object, a shape around a respective user interface object) that a fourth user interface object of the one or more user interface objects is selected (e.g., 806 at FIG. 4B and/or 814 at FIG. 4C). In some embodiments, in response to detecting the rotation of the physical input mechanism, the computer system ceases to display the indication that the third user interface is selected (e.g., as described above at FIG. 4C). Displaying an indication that a fourth user interface object of the one or more user interface objects is selected and ceasing to display the indication that the third user interface is selected in response to detecting the rotation of the physical input mechanism allows the user with more control over the computer system to allow the user to switch a selection of a user interface object while providing visual feedback of which user interface object is selected, thereby providing additional control options without cluttering the user interface with additional user interface objects and providing improved feedback.

In some embodiments, in response to detecting the rotation (e.g., 805b and/or 805d) of the physical input mechanism (e.g., 616), the computer system moves (e.g., in a circular direction, in a lateral direction, and/or in a vertical direction) display of the one or more user interface objects (e.g., 806, 808, 814, and/or 816) (e.g., as described above at FIG. 4B). Moving display of the one or more user interface objects in response to detecting the rotation of the physical input mechanism provides the user with more control over the computer system to allow the user to switch a selection of a user interface object, thereby providing additional control options without cluttering the user interface with additional user interface objects and providing improved feedback.

In some embodiments, in response to detecting the rotation (e.g., 805b and/or 805d) of the physical input mechanism (e.g., 616) while displaying the one or more user interface objects (e.g., 806, 808, 814, and/or 816), the computer system forgoes causing a current value for a setting to be adjusted (e.g., forgoing causing a device that corresponds to the current value for the setting to be adjusted) (e.g., as described above at FIG. 4C). Having the current value for the setting not to be adjusted in response to detecting the rotation of the physical input mechanism while displaying the one or more user interface objects provides the user with more control to only adjust settings when desired, thereby providing additional control options without cluttering the user interface with additional user interface objects.

In some embodiments, while displaying the one or more user interface objects (e.g., 806, 808, 814, and/or 816), the computer system detects an input (e.g., 805b, 805c, and/or 805d) (e.g., an input (e.g., a tap input and/or a rotational input) on a rotatable input mechanism and/or a tap on a control and/or user interface object) (and, In some embodiments, a non-tap input, such as a mouse click, gaze input, voice command, air gesture (e.g., a tap air gesture, a pinch gesture, and/or a flicking air gesture)) that is directed to a fourth user interface object (e.g., 806, 808, 814, and/or 816) of the one or more user interface objects (e.g., 806, 808, 814, and/or 816). In some embodiments, in response to detecting the input that is directed to the fourth user interface object, the computer system displays a scale (e.g., 822) (e.g., a color and/or graphical representation which indicates a scale and/or a range of values) that includes an indication (e.g., 830) of a current value of a setting corresponding to the fourth user interface object. Displaying a scale that includes an indication of a current value of a setting corresponding to the fourth user interface object in response to detecting the input that is directed to the fourth user interface object provides the user with more control over the user interface to cause display of the scale, thereby providing additional control options without cluttering the user interface with additional user interface objects and providing improved feedback.

In some embodiments, while displaying the scale (e.g., 822) that includes the indication (e.g., 830) of the current value of the setting corresponding to the fourth user interface object (e.g., 806, 808, 814, and/or 816), the computer system detects, via the one or more inputs, an input (e.g., 805b, 805c, and/or 805d) (e.g., an input (e.g., a tap input and/or a rotational input) on a rotatable input mechanism and/or a tap on a control and/or user interface object) (and, In some embodiments, a non-tap input, such as a mouse click, gaze input, voice command, air gesture (e.g., a tap air gesture, a pinch gesture, and/or a flicking air gesture)) that is directed to the physical input mechanism (e.g., 616). In some embodiments, in response to detecting the input that is directed to the physical input mechanism, the computer system adjusts the current value of the setting corresponding to the fourth user interface object (e.g., as discussed above at FIG. 4E). In some embodiments, in response to detecting the input that is directed to the physical input mechanism, the computer system causes output of a device (e.g., a fan, thermostat, speaker, window, door, and/or actuator) that corresponds to the setting corresponding to the fourth user interface object (e.g., as described above at FIG. 4E). Causing output of a device that corresponds to the setting corresponding to the fourth user interface object and adjusting the current value of the setting corresponding to the fourth user interface object in response to detecting the input that is directed to the physical input mechanism provides the user with more control of the user interface to adjust the current value of the setting and change the output of a device, thereby providing additional control options without cluttering the user interface with additional user interface objects and providing improved feedback.

In some embodiments, the fourth user interface object (e.g., 806, 808, 814, and/or 816) is displayed at a respective location. In some embodiments, in response to detecting the input (e.g., 805b, 805c, and/or 805d) that is directed to the fourth user interface object, the computer system ceases to display the fourth user interface object at the respective location, wherein the scale (e.g., 822) is displayed at the respective location (e.g., as described above at FIG. 4D). In some embodiments, the scale replaces the fourth user interface object. Ceasing to display the fourth user interface object at the respective location, wherein the scale is displayed at the respective location allows the computer system to cease displaying user interface object(s) when needed and/or when another user interface object should be displayed at the location which gives the user the indication that the user interface object that has ceased to be displayed is not actionable, thereby providing additional control options without cluttering the user interface with additional user interface objects and providing improved feedback.

In some embodiments, while displaying the one or more user interface objects (e.g., 806, 808, 814, and/or 816), the computer system detects an input (e.g., 805b, 805c, and/or 805d) (e.g., an input (e.g., a tap input and/or a rotational input) on a rotatable input mechanism and/or a tap on a control and/or user interface object) (and, In some embodiments, a non-tap input, such as a mouse click, gaze input, voice command, air gesture (e.g., a tap air gesture, a pinch gesture, and/or a flicking air gesture)) that is not directed to the physical input mechanism (e.g., 616). In some embodiments, in response to detecting the input that is not directed to the physical input mechanism, the computer system updates the respective user interface without displaying a scale (e.g., 822) that updates based on movement of the physical input mechanism and without updating display of the one or more user interface objects. Updating the respective user interface without displaying a scale that updates based on movement of the physical input mechanism and without updating display of the one or more user interface objects in response to detecting the input that is not directed to the physical input mechanism provides the user with more control to update the respective user interface in a manner that is based on the input, thereby providing additional control options without cluttering the user interface with additional user interface objects and providing improved feedback.

In some embodiments, detecting the intent to control (e.g., as discussed above at FIG. 4A) the physical input mechanism (e.g., 616) does not include detecting an input (e.g., 805b, 805c, and/or 805d) on (and/or that is touching and/or that is at a location corresponding to the surface of) the physical input mechanism.

Note that details of the processes described above with respect to process 900 (e.g., FIGS. 5A-5B) are also applicable in an analogous manner to other methods described herein. For example, process 700 optionally includes one or more of the characteristics of the various methods described above with reference to process 900.

FIGS. 6A-6G illustrate exemplary user interfaces for changing the appearance of a user interface object in accordance with some embodiments. The user interfaces in these figures are used to illustrate the processes described below, including the processes in FIGS. 7A-7B.

At FIG. 6A, computer system 600 displays temperature control user interface 1004. Temperature control user interface 1004 corresponds to an air conditioning device (e.g., a device capable of heating and/or cooling an area). The air conditioning device has a neutral temperature value of 72 degrees. Computer system 600 is configured to control the air conditioning device while computer system 600 displays temperature control user interface 1004. In some embodiments, the neutral temperature value is a range of temperature settings of the air conditioning device. In some embodiments, the neutral temperature value is based on one or more user preferences. In some embodiments, the neutral temperature value is a median temperature setting of the air conditioning device. In some embodiments, the neutral temperature value is a preset setting (e.g., the neutral temperature value is set by the manufacturer of the air conditioning device or computer system 600).

As illustrated in FIG. 6A, temperature control user interface 1004 includes temperature scale user interface object 1012, temperature value user interface object 1002, and temperature representation user interface object 1006. Temperature scale user interface object 1012 corresponds to a range of temperature settings of the air conditioning device. The leftmost portion of temperature scale user interface object 1012 corresponds to a minimum temperature setting of the air conditioning device and the rightmost portion of temperature scale user interface object 1012 corresponds to a maximum temperature setting of the air conditioning device. Temperature value user interface object 1002 indicates the current temperature setting of the air conditioning device. At FIG. 6A, temperature value user interface object 1002 indicates that the current temperature setting of the air conditioning device is 55 degrees.

Temperature representation user interface object 1006 is also a representation of the current temperature setting of the air conditioning device. As explained in greater detail below, the size of temperature representation user interface object 1006 corresponds to the temperature setting of the air conditioning device. Computer system 600 adjusts the size of the display of temperature representation user interface object 1006 based on the relationship between the current temperature setting of the air conditioning device and the neutral temperature value of the air conditioning device. The closer the temperature setting of the air conditioning device is to the neutral temperature value, the smaller the size of temperature representation user interface object 1006.

Further, the color of temperature representation user interface object 1006 corresponds to the temperature setting of the air conditioning device. When the temperature setting of the air conditioning device is set to a cooler setting, computer system 600 displays temperature representation user interface object 1006 with a cool color (e.g., blue, light blue, and/or teal). When the temperature setting of the air conditioning device is set to a warmer setting, computer system 600 displays temperature representation user interface object 1006 with a warm color (e.g., orange, red, yellow).

At FIG. 6A, computer system 600 displays temperature representation user interface object 1006 as a dark blue color (e.g., as indicated by the density of the hatching within temperature representation user interface object 1006). Computer system 600 adjusts the shade of the color of temperature representation user interface object 1006 based on the relationship between the temperature setting of the air conditioning device and the neutral temperature value of the air conditioning device. Computer system 600 does not adjust the hue of temperature representation user interface object 1006 as the relationship between the temperature setting of the air conditioning device and the neutral temperature value changes.

While the temperature setting of the air conditioning device is less than the neutral temperature value, computer system 600 displays temperature representation user interface object 1006 as a cool color (e.g., blue, light blue, and/or teal). While the temperature setting of the air conditioning device value is less than the neutral temperature value, computer system 600 decreases the intensity (e.g., adds white, increases the tint) of the color of temperature representation user interface object 1006 as the difference between the temperature setting of the air conditioning device and the neutral temperature value decreases. Conversely, while the temperature setting of the air conditioning device is less than the neutral temperature value, computer system 600 increases the intensity (e.g., adds black, adds more shading, decreases the tint) of the color of temperature representation user interface object 1006 as the difference between the temperature setting of the air conditioning device and the neutral temperature value of the air conditioning device increases. In some embodiments, the color of temperature representation user interface object 1006 indicates a temperature category of the current temperature setting of the air conditioning device (e.g., temperature representation user interface object 1006 has a blue color to indicate that the temperature setting of the air conditioning device is set to a cooler temperature and temperature representation user interface object 1006 has a red color to indicate that the temperature setting of the air conditioning device is set to a warmer temperature.

While the temperature setting of the air conditioning device is greater than the neutral temperature value of the air conditioning device, computer system 600 displays temperature representation user interface objection 1006 as a warm color (e.g., orange, red, yellow). While the temperature setting of the air conditioning device is greater than the neutral temperature value, computer system 600 increases the intensity (e.g., adds more shading, decreases the tint, adds black) of the color of temperature representation user interface object 1006 as the difference between the temperature setting of the air conditioning device and the neutral temperature value of the air conditioning device increases. Conversely, while the temperature setting is greater than the neutral temperature value, computer system 600 decreases the intensity (e.g., adds white, increases the tint) of the color of temperature representation user interface object 1006 as the difference between the temperature setting of the air conditioning device and the neutral temperature value of the air conditioning device decreases.

At FIG. 6A, computer system 600 detects input 1005a that corresponds to a rotation of the rotatable input mechanism 616. In some embodiments, input 1005a corresponds to a tap gesture, swipe gesture, voice command, hand gesture, and/or gaze. In some embodiments, rotatable input mechanism 616 includes a display (e.g., a touch-sensitive display). In embodiments when rotatable input mechanism 616 includes a display, computer system 600 displays temperature control user interface 1004 on the display of rotatable input mechanism 616. In some embodiments, computer system 600 displays temperature scale user interface object 1012 around rotatable input mechanism 616.

At FIG. 6B, in response to detecting input 1005a, computer system 600 transmits instructions to the air conditioning device. In response to receiving the instructions from computer system 600, the air conditioning device increases its temperature setting from 55 degrees to 67 degrees. Accordingly, at FIG. 6B, temperature value user interface object 1002 indicates that the current temperature setting of the air conditioning device is 67 degrees. Further, at FIG. 6B, computer system 600 moves the display of temperature value user interface object 1002 rightward on temperature scale user interface object 1012 (e.g., in comparison to the location of the display of temperature value user interface object 1002 at FIG. 6A) to represent the increase of the temperature setting of the air conditioning device. In some embodiments, the temperature setting of the air conditioning device is adjusted based on the direction of the detected rotation of rotatable input mechanism 616 (e.g., the temperature setting of the air conditioning device is increased if computer system 600 detects that rotatable input mechanism 616 is rotated in the clockwise direction or the temperature setting of the air conditioning device is decreased if computer system 600 detects that rotatable input mechanism 616 is rotated in the counterclockwise direction).

As explained above, computer system 600 decreases the size of temperature representation user interface object 1006 as the difference between the temperature setting of the air conditioning device and the neutral temperature value of the air conditioning device decreases. Accordingly, at FIG. 6B, because the difference between the temperature of the air conditioning device and the neutral temperature value of the air conditioning device decreases, computer system 600 decreases the size of temperature representation user interface object 1006 (e.g., in contrast to the size of temperature representation user interface object 1006 at FIG. 6A). In some embodiments, computer system 600 adjusts the size of temperature representation user interface object 1006 (e.g., increases and/or decreases the size of temperature representation user interface object 1006) from a center (e.g., centroid) position of temperature representation user interface object 1006.

At FIG. 6B, as explained above, while the temperature setting of the air conditioning device is less than the neutral temperature value of the air conditioning device, computer system 600 decreases the intensity of the color of temperature representation user interface object 1006 as the difference between the current temperature setting of the air conditioning device and the neutral temperature value decreases. Accordingly, at FIG. 6B, because the difference between the temperature of the air conditioning device and the neutral temperature value decreases, computer system 600 displays temperature representation user interface object 1006 as a lighter blue color (e.g., in contrast to the darker blue color of temperature representation user interface object 1006 at FIG. 6A) (e.g., as indicated by the density of the hatching within temperature representation user interface object 1006 at FIG. 6B). In some embodiments, computer system 600 adjusts the color of temperature representation user interface object 1006 before or after computer system 600 adjusts the size of temperature representation user interface object 1006. In some embodiments, computer system 600 adjusts the size and color of temperature representation user interface object 1006 at the same time. In some embodiments, in response to detecting input 1005a, computer system 600 changes the size or the color of temperature representation user interface object 1006.

At FIG. 6B, computer system 600 detects input 1005b that corresponds to a rotation of rotatable input mechanism 616. In some embodiments, input 1005b corresponds to a voice command, tap gesture, swipe gesture, hand gesture, and/or gaze. In some embodiments, the change in magnitude of the size of temperature representation user interface object 1006 is greater than or less than the change in magnitude of the color intensity of temperature representation user interface object 1006 (e.g., the amount that the size of temperature representation user interface object 1006 changes is greater than the amount that the color of temperature representation user interface object 1006). In some embodiments, the rate of change of the size of temperature representation user interface object 1006 is different than the rate of change of the color of temperature representation user interface object 1006.

At FIG. 6C, in response to detecting input 1005b, computer system 600 transmits instructions to the air conditioning device. The air conditioning device increases its temperature setting from 67 degrees to 72 degrees in response to receiving the instructions from computer system 600. Accordingly, at FIG. 6C, temperature value user interface object 1002 indicates that the temperature setting of the air conditioning device is 72 degrees. Further, at FIG. 6C, computer system 600 moves the display of temperature value user interface object 1002 to the right on temperature scale user interface object 1012 (e.g., in comparison to the positioning of temperature value user interface object 1002 at FIG. 6B) to represent the increase of the temperature setting of the air conditioning device.

As discussed above, 72 degrees corresponds to the neutral temperature value of the air conditioning device. Accordingly, at FIG. 6C, the temperature setting of the air conditioning device is set to the neutral temperature value. At FIG. 6C, computer system 600 displays temperature representation user interface object 1006 as colorless (e.g., as indicated by the absence of hatching within temperature representation user interface object 1006) and at a minimum size. That is, when the temperature setting of the air conditioning device corresponds to the neutral temperature value, computer system 600 displays temperature representation user interface object 1006 as colorless and at a minimum size.

At FIG. 6C, computer system 600 detects input 1005c that corresponds to a rotation of rotatable input mechanism 616. In some embodiments, computer system 600 ceases to display temperature representation user interface object 1006 when the temperature setting of the air conditioning device corresponds to the neutral temperature value. In some embodiments, computer system 600 displays temperature representation user interface object 1006 at a maximum size when the air conditioning device is set to a maximum or minimum temperature setting. In some embodiments, input 1005c corresponds to a voice command, tap gesture, swipe gesture, hand gesture, and/or gaze.

At FIG. 6D, in response to detecting input 1005c, computer system 600 transmits instructions to the air conditioning device. In response to receiving the instructions, the air conditioning device increases its temperature setting from 72 degrees to 80 degrees. Accordingly, at FIG. 6D, temperature value user interface object 1002 indicates that the current temperature setting of the air conditioning device is 80 degrees. Further, at FIG. 6D, computer system 600 moves the display of temperature value user interface object 1002 to the right on temperature scale user interface object 1012 (e.g., in comparison to the positioning of temperature value user interface object 1002 at FIG. 6C) to represent the increase of the temperature setting of the air conditioning device.

As explained above, computer system 600 increases the size of temperature representation user interface object 1006 as the difference between the temperature setting of the air conditioning device and the neutral temperature value of the air conditioning device increases. At FIG. 6D, because the difference between the temperature setting of the air conditioning device and the neutral temperature value of the air conditioning device increases, computer system 600 increases the size of the display of temperature representation user interface object 1006 (e.g., in comparison to the size of temperature representation user interface object 1006 at FIG. 6C). In some embodiments, computer system 600 displays temperature representation user interface object 1006 as the same size when the temperature setting of the air conditioning device is greater than or less than the neutral temperature value by the same amount (e.g., computer system 600 displays temperature representation user interface object 1006 as the same size when the temperature setting the air conditioning device is five degrees greater than or five degrees less than the neutral temperature value).

Further, as explained above, computer system 600 displays temperature representation user interface object 1006 with a warm color while the temperature setting of the air conditioning device is greater than the neutral temperature value of the air conditioning device. Accordingly, at FIG. 6D, computer system 600 displays temperature representation user interface object 1006 as a light red color (e.g., as indicated by the hatching within temperature representation user interface object 1006 at FIG. 6D). At FIG. 6D, computer system 600 detects input 1005d that corresponds to a rotation of rotatable input mechanism 616. In some embodiments, input 1005d corresponds to a voice input, tap gesture, swipe gesture, hand gesture, voice command, and/or gaze.

At FIG. 6E, in response to detecting input 1005d, computer system 600 transmits instructions to the air conditioning device. The air conditioning device increases its temperature setting from 80 degrees to 90 degrees in response to receiving the instructions from computer system 600. Accordingly, at FIG. 6E, temperature value user interface object 1002 indicates that the current temperature setting of the air conditioning device is 90 degrees. Further, at FIG. 6E, computer system 600 moves the display of temperature value user interface object 1002 to the right on temperature scale user interface object 1012 (e.g., in comparison to the positioning of temperature value user interface object 1002 at FIG. 6D) to represent the increase of the temperature setting of the air conditioning device.

At FIG. 6E, because the difference between the temperature setting of the air conditioning device and the neutral temperature value of the air conditioning device increases, computer system 600 increases the size of the display of temperature representation user interface object 1006 (e.g., in comparison to the size of temperature representation user interface object 1006 at FIG. 6D). Further, at FIG. 6E, because the difference between the temperature setting of the air conditioning device and the neutral temperature value increases while the temperature of the setting of the air conditioning device is greater than the neutral temperature value, computer system 600 increases the intensity of the color of temperature representation user interface object 1006 (e.g., as indicated by the density of the hatching within temperature representation user interface object 1006). Accordingly, at FIG. 6E, computer system 600 displays temperature representation user interface object 1006 as a darker red color (e.g., in contrast to the light red color of temperature representation user interface object 1006 at FIG. 6D). In some embodiments, in response to detecting input 1005d, computer system 600 changes the size or the color of temperature representation user interface object 1006.

At FIG. 6F, computer system 600 displays volume control user interface 1030. Volume control user interface 1030 corresponds to one or more speaker devices. Computer system 600 is configured to control the one or more speaker devices while computer system 600 displays volume control user interface 1030. In some embodiments, computer system 600 displays volume control user interface 1030 in response to detecting an input (e.g., a rotation of rotatable input mechanism 616, a swipe gesture, a tap gesture, a voice command, and/or depression of rotatable input mechanism 616) while computer system 600 displays temperature control user interface 1004. In some embodiments, when rotatable input mechanism 616 includes a display, computer system 600 displays volume control user interface 1030 on the display of rotatable input mechanism 616. In some embodiments, computer system 600 displays volume control user interface 1030 in response to detecting an input that corresponds to selection of volume value user interface object 614 (e.g., as discussed above in reference to FIG. 2A). In some embodiments, computer system 600 fades out the display of temperature representation user interface object 1006 as a part of displaying volume control user interface 1030.

As illustrated in FIG. 6F, volume control user interface 1030 includes volume scale user interface object 1032, volume level user interface object 1034, and volume representation user interface object 1036. Volume scale user interface object 1032 corresponds to a range of volume settings of the one or more speaker devices. The leftmost portion of volume scale user interface object 1032 corresponds to a minimum volume setting of the one or more speaker devices and the rightmost portion of volume scale user interface object 1032 corresponds to a maximum volume setting of the one or more speaker devices.

Volume level user interface object 1034 indicates the current volume setting of the one or more speaker devices. Accordingly, at FIG. 6F, the one or more speaker devices are set to a volume level of ten. Further, the size of volume representation user interface object 1036 indicates the volume setting of the one or more speaker devices. At FIG. 6F, computer system 600 displays volume representation user interface object 1036 without any color (e.g., as indicated by the absence of hatching within representing volume representation user interface object 1036).

Computer system 600 adjusts the size of volume representation user interface object 1036 based on the volume level of the one or more speakers. The size of volume representation user interface object 1036 and the volume setting of the one or more speaker devices are directly correlated. That is, the size of volume representation user interface object 1036 increases as the volume setting of the one or more speaker devices increases. In some embodiments, the size of volume representation user interface object 1036 decreases as the volume setting of the one or more speaker devices increases.

Unlike temperature representation user interface object 1006, computer system 600 only changes one visual characteristic of volume representation user interface object 1036 based on changes to the operation (e.g., changes to the volume) of the one or more speaker devices. That is, computer system 600 changes the size of the display of volume representation user interface object 1036 and does not change the hue of volume representation user interface object 1036 based on changes to the volume setting of the one or more speaker devices. At FIG. 6F, computer system 600 detects input 1050f that corresponds to a rotation of rotatable input mechanism 616. In some embodiments, input 1005f corresponds to a voice command, tap gesture, swipe gesture, hand gesture, and/or gaze. In some embodiments, computer system 600 changes three or more visual characteristics of temperature representation user interface object 1006 in response to detecting a change in the operation of the one or more speaker devices. In some embodiments, computer system 600 does not change any visual characteristics of temperature representation user interface object 1006 in response to detecting a change in the operation of the one or more speaker devices.

At FIG. 6G, in response to detecting input 1005f, computer system 600 transmits instructions to the one or more speaker devices. At FIG. 6G, in response to receiving the instructions from computer system 600, the one or more speaker devices increase their volume setting from 10 to 80. Accordingly, at FIG. 6G, volume level user interface object 1034 indicates that the volume setting of the one or more speaker devices is 80. Further, at FIG. 6G, computer system 600 moves the display of volume level user interface object 1034 to the right on volume scale user interface object 1032 (e.g., in comparison to the positioning of volume level user interface object 1034 at FIG. 6F) to represent the increase of the volume setting of the one or more speaker devices.

As explained above, the size of volume representation user interface object 1036 has a direct correlation with the volume setting of the one or more speaker devices. Accordingly, at FIG. 6G, because the volume setting of the one or more speaker devices increases, computer system 600 increases the size of the display of volume representation user interface object 1036 (e.g., in comparison to the size of volume representation user interface object 1036 at FIG. 6F).

At FIG. 6G, computer system 600 continues to display volume representation user interface object 1036 without any color. Computer system 600 changes different visual properties of volume representation user interface object 1036 in comparison to temperature representation user interface object 1006. For example, when the temperature setting of the air conditioning device is adjusted, computer system 600 changes the size and color intensity of temperature representation user interface object 1006. In contrast, when the volume setting of the one or more speaker devices is changed, computer system 600 only changes the size of volume representation user interface object 1036.

FIGS. 7A-7B is a flow diagram illustrating a method (e.g., process 1100) for changing the appearance of a user interface object in accordance with some embodiments. Some operations in process 1100 are, optionally, combined, the orders of some operations are, optionally, changed, and some operations are, optionally, omitted.

As described below, process 1100 provides an intuitive way for changing the appearance of a user interface object. Process 1100 reduces the cognitive burden on a user for changing the appearance of a user interface object, thereby creating a more efficient human-machine interface. For battery-operated computing devices, enabling a user to change the appearance of a user interface object faster and more efficiently conserves power and increases the time between battery charges.

In some embodiments, process 1100 is performed at a computer system (e.g., 600) that is in communication with a display component (e.g., 604) (e.g., a display screen and/or a touch-sensitive display) and one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras).

The computer system displays (1102), via the display component (e.g., 604), a visual representation (e.g., 1006 and/or 1036) (e.g., a shape, a blob, and/or an area) of a value (−100-100, 0-100%, high, medium, low, hot, warm, cold, very cold, and/or very high) of a setting (e.g., as described above in relation to process 700), wherein the visual representation (e.g., a first portion of the visual representation) includes a first visual property (e.g., size and/or shape of 1006 and/or 1036) (e.g., a size, a shape, a length, and/or a width) (e.g., in a first state) and a second visual property (e.g., size and/or shape of 1006 and/or 1036) (e.g., a color, a tint, a shade, and/or a highlighting) (e.g., in a second state) that are displayed based on the value of the setting, and wherein the first visual property is different from the second visual property. In some embodiments, the first visual property is a first type of visual property and the second visual property is a second type of visual property different from the first type.

While displaying the visual representation (e.g., 1006 and/or 1036) including the first visual property (e.g., size and/or shape of 1006 and/or 1036) and the second visual property (e.g., size and/or shape of 1006 and/or 1036), the computer system detects (1104), via the one or more input devices, a respective input (e.g., 1005a, 1005b, 1005c, 1005d, and/or 1005f) (e.g., a touch input and/or a rotational input) (e.g., an input (e.g., a tap input and/or a rotational input) on a rotatable input mechanism and/or a tap on a control and/or user interface object) (and, In some embodiments, a non-tap input, such as a mouse click, gaze input, voice command, air gesture (e.g., a tap air gesture, a pinch gesture, and/or a flicking air gesture)).

In response to (1106) detecting the respective input (e.g., 1005a, 1005b, 1005c, 1005d, and/or 1005f) and in accordance with the setting being a first type of setting and the respective input (e.g., 1005a, 1005b, 1005c, 1005d, and/or 1005f) being in a first direction (e.g., right, left, up, down, clockwise, and/or counterclockwise), the computer system changes (1108) the first visual property (e.g., size and/or shape of 1006 and/or 1036) of the visual representation (e.g., 1006 and/or 1036) in a first manner (e.g., increasing the size of and/or the amount of color, decreasing the size of and/or the amount of color, changing the color of, darkening, and/or brightening) without changing the second visual property (e.g., size and/or shape of 1006 and/or 1036) of the visual representation (e.g., as described above at FIGS. 6B and 6E).

In response to (1106) detecting the respective input and in accordance with the setting being the first type of setting (e.g., as described above in relation to process 700) and the respective input (e.g., 1005a, 1005b, 1005c, 1005d, and/or 1005f) being in a second direction that is different from (e.g., is in the opposite direction of and/or not in the same direction as) the first direction, the computer system changes (1110) the first visual property of the visual representation (e.g., 1006 and/or 1036) in a second manner (e.g., increasing the size of and/or the amount of color, decreasing the size of and/or the amount of color, changing the color of, darkening, and/or brightening) without changing the second visual property (e.g., size and/or shape of 1006 and/or 1036) of the visual representation, wherein the first manner is different from the second manner (e.g., as described above at FIG. 6B).

In response to (1106) detecting the respective input and in accordance with the setting being a second type of setting (e.g., as described above in relation to process 700) that is different from the first type of setting and the respective input (e.g., 1005a, 1005b, 1005c, 1005d, and/or 1005f) being in the first direction, the computer system changes (1112) the first visual property (e.g., size and/or shape of 1006 and/or 1036) of the visual representation (e.g., 1006 and/or 1036) in the first manner without changing the second visual property (e.g., size and/or shape of 1006 and/or 1036) of the visual representation (e.g., as described above at FIGS. 6B and 6E).

In response to (1106) detecting the respective input and in accordance with the setting being the second type of setting and the respective input (e.g., 1005a, 1005b, 1005c, 1005d, and/or 1005f) being in the second direction, the computer system changes (1114) the first visual property (e.g., size and/or shape of 1006 and/or 1036) of the visual representation (e.g., 1006 and/or 1036) in the second manner and changing the second visual property (e.g., size and/or shape of 1006 and/or 1036) of the visual representation in a third manner (e.g., increasing the size of and/or the amount of color, decreasing the size of and/or the amount of color, changing the color of, darkening, and/or brightening) that is different from the first manner and the second manner (e.g., as discussed above at FIG. 6B). In some embodiments, the first manner is the opposite of the second manner (e.g., increasing versus decreasing a visual characteristic), and the third manner (e.g., not increasing or decreasing the visual characteristic) is not opposite of the first manner or the second manner. Changing the first visual property of the visual representation and/or changing the second visual property of the visual representation differently based on prescribed conditions being met allows the computer system to automatically indicate to the user how the respective input is causing a setting to be changed, thereby providing additional control options without cluttering the user interface with additional user interface objects, performing an operation when a set of conditions has been met without requiring further user input, and providing improved feedback.

In some embodiments, the one or more inputs devices includes a physical input mechanism (e.g., 616) (e.g., as described above in relation to process 700). In some embodiments, the physical input mechanism includes the display component (e.g., 604). In some embodiments, one or more user interface objects and/or the visual representation is displayed on the physical input mechanism.

In some embodiments, the physical input mechanism (e.g., 616) is a rotatable input mechanism (e.g., as described above in relation to process 700). In some embodiments, the respective input (e.g., 1005a, 1005b, 1005c, 1005d, and/or 1005f) includes a rotation (e.g., as described above in relation to process 700) of the rotatable input mechanism. Changing the first visual property of the visual representation and/or changing the second visual property of the visual representation on a rotatable input mechanism differently based on prescribed conditions being met allows the computer system to automatically indicate to the user how the respective input directed to the rotatable input mechanism is causing a setting to be changed, thereby providing additional control options without cluttering the user interface with additional user interface objects, performing an operation when a set of conditions has been met without requiring further user input, and providing improved feedback.

In some embodiments, the first visual property (e.g., size and/or shape of 1006 and/or 1036) is a size (e.g., length, width, and/or height) of the visual representation (e.g., 1006 and/or 1036). Changing (or not changing) the size of the visual representation based on prescribed conditions being met allows the computer system to automatically indicate to the user how the respective input is causing a setting to be changed, thereby providing additional control options without cluttering the user interface with additional user interface objects, performing an operation when a set of conditions has been met without requiring further user input, and providing improved feedback.

In some embodiments, the first visual property (e.g., size and/or shape of 1006 and/or 1036) indicates a value (e.g., 5 degrees-100 degrees, 0%-100% of sound, high, medium, low, on, and/or off) of the setting. Changing (or not changing) the first visual property of the visual representation, where the first visual property indicates the value of the setting, based on prescribed conditions being met allows the computer system to automatically indicate to the user how the respective input is causing a setting to be changed, thereby providing additional control options without cluttering the user interface with additional user interface objects, performing an operation when a set of conditions has been met without requiring further user input, and providing improved feedback.

In some embodiments, in response to detecting the respective input (e.g., 1005a, 1005b, 1005c, 1005d, and/or 1005f) and in accordance with the setting being the second type of setting and the respective input being in the second direction: the first visual property (e.g., size and/or shape of 1006 and/or 1036) of the visual representation (e.g., 1006 and/or 1036) is changed in the second manner at a first rate (e.g., a speed, velocity, acceleration, and/or amount) and the second visual property (e.g., size and/or shape of 1006 and/or 1036) of the visual representation is changed in the third manner at a second rate (e.g., a speed, velocity, acceleration, and/or amount) that is slower than the first rate (e.g., as described above at FIG. 6B). Changing (or not changing) the first visual property of the visual representation and/or changing the second visual property of the visual representation on a rotatable input mechanism at a different rate allows the computer system to automatically indicate how different aspects of the setting is being changed and/or categorized differently based on the value of the setting changing, thereby performing an operation when a set of conditions has been met without requiring further user input and providing improved feedback.

In some embodiments, changing the first visual property (e.g., size and/or shape of 1006 and/or 1036) of the visual representation (e.g., 1006 and/or 1036) in the first manner includes expanding (e.g., increasing and/or enlarging) a size of the visual representation (e.g., as described above at FIG. 6D). In some embodiments, changing the first visual property of the visual representation in the second manner includes compressing (e.g., decreasing and/or shrinking) the size of the visual representation (e.g., as described above at FIG. 6B). Changing (or not changing) the first visual property of the visual representation by expanding and/or compressing the size of the visual representation based on prescribed conditions being met allows the computer system to automatically indicate to the user how the respective input is causing a setting to be changed, thereby providing additional control options without cluttering the user interface with additional user interface objects, performing an operation when a set of conditions has been met without requiring further user input, and providing improved feedback.

In some embodiments, the size of the visual representation (e.g., 1006 and/or 1036) is expanded from a centroid (e.g., a center and/or a middle portion and/or point) of the visual representation. In some embodiments, the size of the visual representation is compressed towards the centroid of the visual representation (e.g., as described above at FIG. 6B). Changing (or not changing) the first visual property of the visual representation by expanding and/or compressing the size of the visual representation toward a centroid based on prescribed conditions being met allows the computer system to automatically indicate to the user how the respective input is causing a setting to be changed, thereby providing additional control options without cluttering the user interface with additional user interface objects, performing an operation when a set of conditions has been met without requiring further user input, and providing improved feedback.

In some embodiments, the second visual property (e.g., size and/or shape of 1006 and/or 1036) is a color (e.g., red, blue, green, yellow, etc.; a gradient color; and/or a solid color) of the visual representation (e.g., 1006 and/or 1036). Changing (or not changing) the color of the visual representation based on prescribed conditions being met allows the computer system to automatically indicate to the user how the respective input is causing a setting to be changed, thereby providing additional control options without cluttering the user interface with additional user interface objects, performing an operation when a set of conditions has been met without requiring further user input, and providing improved feedback.

In some embodiments, the second visual property (e.g., size and/or shape of 1006 and/or 1036) indicates a category (and/or an intensity) that corresponds to the setting (e.g., hot, cold, neutral, loud, soft, dangerous, and/or safe) (e.g., as described above at FIG. 6A). Changing (or not changing) the second property of the visual representation to indicate an intensity corresponding to the setting based on prescribed conditions being met allows the computer system to automatically indicate to the user how the respective input is causing a setting to be changed, thereby providing additional control options without cluttering the user interface with additional user interface objects, performing an operation when a set of conditions has been met without requiring further user input, and providing improved feedback.

In some embodiments, after detecting the respective input (e.g., 1005a, 1005b, 1005c, 1005d, and/or 1005f), the computer system detects, via the one or more input devices, a second input (e.g., 1005a, 1005b, 1005c, 1005d, and/or 1005f) (e.g., an input (e.g., a tap input and/or a rotational input) on a rotatable input mechanism and/or a tap on a control and/or user interface object) (and, In some embodiments, a non-tap input, such as a mouse click, gaze input, voice command, air gesture (e.g., a tap air gesture, a pinch gesture, and/or a flicking air gesture)) that is different from the respective input, wherein the second input is in the same direction as the respective input. In some embodiments, in response to detecting the second input and in accordance with the setting being the first type of setting, the computer system forgoes changing the second visual property (e.g., size and/or shape of 1006 and/or 1036) of the visual representation (e.g., 1006 and/or 1036). In some embodiments, in response to detecting the second input and in accordance with the setting being the second type of setting, the computer system changes the second visual property of the visual representation in a fourth manner (e.g., that is different from the first manner, the second manner, and/or the third manner). Changing (or not changing) the second visual property of the visual representation in a fourth manner based on the type of setting allows the computer system to automatically indicate how one setting is changing in one manner while not indicating how another setting is changing in the same (or a similar) manner, thereby providing additional control options without cluttering the user interface with additional user interface objects, performing an operation when a set of conditions has been met without requiring further user input, and providing improved feedback.

In some embodiments, after (e.g., as a result of and/or, In some embodiments, while) the second visual property (e.g., size and/or shape of 1006 and/or 1036) of the visual representation (e.g., 1006 and/or 1036) is changed in the fourth manner, the first visual property (e.g., size and/or shape of 1006 and/or 1036) of the visual representation is (and/or is changed to be) the same as the first visual property was before the respective input (e.g., 1005a, 1005b, 1005c, 1005d, and/or 1005f) was detected (e.g., size of 50+ degrees past natural temp is same as the size of 50− degrees passed neutral temp) (e.g., as described above at FIG. 6D). Having the first visual property of the visual representation be the same as the first visual property was before the respective input was detected after the second visual property of the visual representation is changed in the fourth manner allows the computer system to automatically indicate how a setting is changed while also indicating the relational aspect of the change to another value of the setting, thereby performing an operation when a set of conditions has been met without requiring further user input and providing improved feedback.

In some embodiments, after (e.g., as a result of and/or while) the second visual property (e.g., size and/or shape of 1006 and/or 1036) of the visual representation (e.g., 1006 and/or 1036) is changed in the third manner, the first visual property (e.g., size and/or shape of 1006 and/or 1036) is at a terminal value (e.g., minimum (e.g., smallest size and/or lightest color) or maximum (e.g., largest size and/or darkest color)) for the first visual property (e.g., as described above at FIG. 6C). Having the first visual property of the visual representation be at a terminal value for the property after the second visual property of the visual representation is changed in the third manner allows the computer system to automatically indication that the setting cannot be changed in a manner more than it has been changed, thereby performing an operation when a set of conditions has been met without requiring further user input and providing improved feedback.

In some embodiments, the computer system (e.g., 600) is in communication with a first device (e.g., a fan, a thermostat, a speaker, a door, a window, and/or a chair). In some embodiments, in response to detecting the respective input (e.g., 1005a, 1005b, 1005c, 1005d, and/or 1005f), the computer system causes output of the first device to be adjusted (e.g., as described above at FIGS. 6B-6E) (e.g., while detecting the respective input and/or based on the speed and/or direction of the respective input). Causing output of the first device to be adjusted in response to detecting the respective input provides the user with more control over the computer system to change how the first device is outputting, thereby performing an operation when a set of conditions has been met without requiring further user input.

In some embodiments, the second type of setting is a type of setting (e.g., a temperature setting, a fan setting, a window tint setting, a window and/or door opening and/or closing setting) that impacts (e.g., changes, modifies, adjusts) temperature of the environment. In some embodiments, the first type of setting is not a type of setting that impacts temperature of the environment (e.g., as described above at FIGS. 6A and 6F).

In some embodiments, the setting is a first setting. In some embodiments, while displaying the user interface that includes the visual representation (e.g., 1006 and/or 1036) of the setting, the computer system detects a request to select a second setting that is different from the first setting. In some embodiments, in response to detecting the request to select the second setting, the computer system ceases to (e.g., fading out and/or gradually fading out the) display the visual representation of the value of the setting (e.g., as described above at FIG. 6F). Ceasing to display the visual representation of the value of the setting in response to detecting the request to select the second setting allows the computer system to cease displaying user interface objects when the user interface objects are no longer needed, which declutters the user interface and preserves screen real estate.

Note that details of the processes described above with respect to process 1100 (e.g., FIGS. 7A-7B) are also applicable in an analogous manner to the methods described herein. For example, process 700 optionally includes one or more characteristics of the various methods described above with reference to process 1100. For example, a scale can be displayed using the techniques described above in relation to process 700, where the appearance of the scale is adjusted using one or more techniques described below in relation to process 1100.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

What is claimed is:

1. A method, comprising:
at a computer system that is in communication with a display component and one or more input devices:
displaying, via the display component:
a plurality of user interface objects including a first user interface object corresponding to a first setting and a second user interface object corresponding to a second setting that is different from the first setting;
a first representation of a current value for the first setting; and
a second representation of a current value for the second setting;
while displaying the first user interface object, the second user interface object, the first representation, and the second representation, detecting, via the one or more input devices, a first input; and
in response to detecting the first input:
in accordance with a determination that the first input corresponds to selection of the first user interface object, updating display of the first user interface object to include a first scale corresponding to the first setting without updating display of the second user interface object to include a second scale corresponding to the second setting; and
in accordance with a determination that the first input corresponds to selection of the second user interface object, updating display of the second user interface object to include a second scale corresponding to the second setting without updating display of the first user interface object to include the first scale.

2. The method of claim 1, wherein the one or more inputs devices includes a first rotatable input mechanism, and wherein the first input is an input that is directed to the first rotatable input mechanism.

3. The method of claim 1, wherein the one or more input devices includes a first touch-sensitive display, and wherein the first input is an input that is directed to the first touch-sensitive display.

4. The method of claim 1, wherein the one or more inputs devices includes a second rotatable input mechanism, and wherein display of the plurality of user interface objects at least partially circumscribes the second rotatable input mechanism.

5. The method of claim 1, further comprising:
while displaying, via the display component, the first user interface object that includes the first scale, detecting, via the one or more input devices, a second input; and
in response to detecting the second input and in accordance with a determination that the second input corresponds to selection of the first user interface object, displaying, via the display component, a third scale corresponding to the first setting, wherein the third scale includes an enlarged representation of the first scale.

6. The method of claim 5, wherein the one or more input devices includes a second touch-sensitive display, and wherein the second input is an input that is directed to second touch-sensitive display.

7. The method of claim 5, wherein the one or more inputs devices includes a third rotatable input mechanism, and wherein the second input is an input that is directed to the third rotatable input mechanism.

8. The method of claim 5, further comprising:
in response to detecting the second input and in accordance with a determination that the second input corresponds to selection of the second user interface object, updating display of the second user interface object to include the second scale corresponding to the second setting.

9. The method of claim 5, wherein the one or more inputs devices includes a fourth rotatable input mechanism, the method further comprising:
while displaying, via the display component, the second user interface object that includes the second scale, detecting, via the one or more input devices, a third input; and
in response to detecting the third input and in accordance with a determination that the third input corresponds to selection of the second user interface object, displaying, via the display component, a fourth scale corresponding to the second setting, wherein:
the fourth scale includes an enlarged representation of the second scale;
while the fourth scale is displayed, display of the fourth scale surrounds the fourth rotatable input mechanism by a first amount; and
while the third scale is displayed, display of the third scale surrounds the fourth rotatable input mechanism by a second amount that is different from the first amount.

10. The method of claim 9, further comprising:
in response to detecting the second input and in accordance with a determination that the second input corresponds to selection of the first user interface object, displaying, via the display component, an indication on the third scale at a location corresponding to a current value of the first setting.

11. The method of claim 10, further comprising:
in response to detecting the third input and in accordance with a determination that the third input corresponds to selection of the second user interface object, displaying, via the display component, an indication on the fourth scale at a location corresponding to a current value of the second setting, wherein display of the indication on the fourth scale is visually different from display of the indication on the third scale.

12. The method of claim 9, further comprising:
while displaying, via the display component, the third scale or the fourth scale, detecting a rotation of a fifth rotatable input mechanism; and
in response to detecting the rotation of the fifth rotatable input mechanism:
in accordance with a determination that the third scale was displayed while the rotation of the physical input mechanism was detected, generating a first set of one or more haptics; and
in accordance with a determination that the fourth scale was displayed while the rotation of the physical input mechanism was detected, generating a second set of one or more haptics that is different from the first set of one or more haptics.

13. The method of claim 12, further comprising:
in response to detecting the first input, generating a third set of one or haptics that is different from the first set of one or more haptics and the second set of one or more haptics.

14. The method of claim 5, further comprising:
in response to detecting the second input and in accordance with a determination that the second input corresponds to selection of the first user interface object, displaying, via the display component, a numerical representation of the current value for the first setting concurrently with the third scale, wherein the numerical representation of the current value for the first setting was not previously displayed before the second input was detected.

15. The method of claim 5, further comprising:
while displaying, via the display component, the third scale, detecting an input corresponding to a movement input; and
in response to detecting the input corresponding to the movement input:
updating the current value for the first setting to a new value based on movement of the input corresponding to the movement input; and
causing output of a device corresponding to the first setting to change.

16. The method of claim 15, wherein the computer system is in communication with a sixth rotatable input mechanism, and wherein the input corresponding to the movement input is a rotation of the sixth rotatable input mechanism.

17. The method of claim 16, wherein the sixth rotatable input mechanism includes a respective display, and wherein the respective display includes a user interface that is updated as the current value for the first setting is updated.

18. The method of claim 5, further comprising:
after displaying, via the display component, the third scale corresponding to the first setting and in accordance with a determination that an input has not been detected for a predetermined period of time, displaying the plurality of controls.

19. The method of claim 5, wherein the computer system is in communication with a seventh rotatable input mechanism, the method further comprising:
in response to detecting an input directed to the seventh rotatable input mechanism, displaying the plurality of controls.

20. The method of claim 19, wherein displaying the plurality of controls in response to detecting an input directed to the seventh rotatable input mechanism includes displaying the first user interface object that includes the first scale and the second user interface object without displaying the second scale.

21. The method of claim 1, wherein display of the second scale is visually different from display of the first scale.

22. A non-transitory computer-readable storage medium storing one or more programs configured to be executed by one or more processors of a computer system that is in communication with a display component and one or more input devices, the one or more programs including instructions for:
displaying, via the display component:
a plurality of user interface objects including a first user interface object corresponding to a first setting and a second user interface object corresponding to a second setting that is different from the first setting;
a first representation of a current value for the first setting; and
a second representation of a current value for the second setting;
while displaying the first user interface object, the second user interface object, the first representation, and the second representation, detecting, via the one or more input devices, a first input; and
in response to detecting the first input:
in accordance with a determination that the first input corresponds to selection of the first user interface object, updating display of the first user interface object to include a first scale corresponding to the first setting without updating display of the second user interface object to include a second scale corresponding to the second setting; and
in accordance with a determination that the first input corresponds to selection of the second user interface object, updating display of the second user interface object to include a second scale corresponding to the second setting without updating display of the first user interface object to include the first scale.

23. A computer system that is in communication with a display component and one or more input devices, comprising:
one or more processors; and
memory storing one or more programs configured to be executed by the one or more processors, the one or more programs including instructions for:
displaying, via the display component:
a plurality of user interface objects including a first user interface object corresponding to a first setting and a second user interface object corresponding to a second setting that is different from the first setting;
a first representation of a current value for the first setting; and
a second representation of a current value for the second setting;
while displaying the first user interface object, the second user interface object, the first representation, and the second representation, detecting, via the one or more input devices, a first input; and
in response to detecting the first input:
in accordance with a determination that the first input corresponds to selection of the first user interface object, updating display of the first user interface object to include a first scale corresponding to the first setting without updating display of the second user interface object to include a second scale corresponding to the second setting; and
in accordance with a determination that the first input corresponds to selection of the second user interface object, updating display of the second user interface object to include a second scale corresponding to the second setting without updating display of the first user interface object to include the first scale.
